(19) United States
(12) Patent Application Publication
(10) Pub. No.: US 2011/0215127 A1
(43) Pub. Date: Sep. 8, 2011

(54) TOOLKIT APPARATUS AND METHOD

(76) Inventor: Michael C. LEE, Pearland, TX (US)

(21) Appl. No.: 12/716,808

(22) Filed: Mar. 3, 2010

(51) Int. Cl. A45F 5/00; A62B 35/04

(52) U.S. Cl. 224/580; 224/584; 224/254

(57) ABSTRACT

An apparatus includes one or more tools, wherein each one of the one or more tools are connected to a shock absorbing member, wherein the shock absorbing member includes a plurality of hooks. A system for preventing the dropping of one or more items includes a member, wherein each one of the one or more items are connected to the member, wherein the member includes a plurality of connectors, wherein the member further includes a plurality of portions, wherein each one of the plurality of connectors is connected to a respective one of the plurality of portions, and wherein each one of the one or more items is connected to an end of a respective one of the plurality of portions.

### BACKGROUND

The description herein generally relates to the field of toolkits. The description also generally relates to safety features relating to the use of tools at a height.

Conventionally, when tools have been used at high locations, there has been the danger of the user losing a grip on the tool and then dropping the tool onto the lower work areas, where there might be other persons or objects that may be harmed by the dropped tools. Alternatively, a tool has been tethered to the user so that when the tool is dropped the tether prevents the tool from being dropped onto the bottom. However, often a tool is of a design and weight such that the dropping of the tool might harm the user. For example, a very heavy tool being dropped might deliver a strong force to the attached point of the user. There is a need for using tools in a raised environment where even if a tool is dropped there is less danger for the user and also for the persons or objects lying below the user.

### SUMMARY

In one aspect, an apparatus includes one or more tools, wherein each one of the one or more tools are connected to a shock absorbing member, wherein the shock absorbing member includes a plurality of hooks.

In another aspect, a system for preventing the dropping of one or more items includes a member, wherein each one of the one or more items are connected to the member, wherein the member includes a plurality of connectors, wherein the member further includes a plurality of portions, wherein each one of the plurality of connectors is connected to a respective one of the plurality of portions, and wherein each one of the one or more items is connected to an end of a respective one of the plurality of portions.

In addition to the foregoing, other system aspects are described in the claims, drawings, and text forming a part of the present disclosure.

The foregoing summary is only illustrative and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exemplary embodiment of the present invention.

FIG. 2 is an exemplary embodiment of the present invention.

FIG. 3 is an exemplary embodiment of the present invention.

FIG. 4 is an exemplary embodiment of the present invention.

FIG. 5 is an exemplary embodiment of the present invention.

FIG. 6 is an exemplary embodiment of the present invention.

FIG. 7 is an exemplary embodiment of the present invention.

FIG. 8 is an exemplary embodiment of the present invention.

FIG. 9 is an exemplary embodiment of the present invention.

FIG. 10 is an exemplary embodiment of the present invention.

FIG. 11 is an exemplary embodiment of the present invention.

FIG. 12 is an exemplary embodiment of the present invention.

FIG. 13 is an exemplary embodiment of the present invention.

FIG. 14 is an exemplary embodiment of the present invention.

FIG. 15 is an exemplary embodiment of the present invention.

FIG. 16 is an exemplary embodiment of the present invention.

FIG. 17 is an exemplary embodiment of the present invention.

FIG. 18 is an exemplary embodiment of the present invention.

FIG. 19 is an exemplary embodiment of the present invention.

FIG. 20 is an exemplary embodiment of the present invention.

FIG. 21 is an exemplary embodiment of the present invention.

FIG. 22 is an exemplary embodiment of the present invention.

FIG. 23 is an exemplary embodiment of the present invention.

FIG. 24 is an exemplary embodiment of the present invention.

FIG. 25 is an exemplary embodiment of the present invention.

FIG. 26 is an exemplary embodiment of the present invention.

FIG. 27 is an exemplary embodiment of the present invention.

FIG. 28 is an exemplary embodiment of the present invention.

FIG. 29 is an exemplary embodiment of the present invention.

FIG. 30 is an exemplary embodiment of the present invention.

FIG. 31 is an exemplary embodiment of the present invention.

FIG. 32 is an exemplary embodiment of the present invention.

FIG. 33 is an exemplary embodiment of the present invention.

FIG. 34 is an exemplary embodiment of the present invention.

FIG. 35 is an exemplary embodiment of the present invention.

FIG. 36 is an exemplary embodiment of the present invention.

FIG. 37 is an exemplary embodiment of the present invention.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

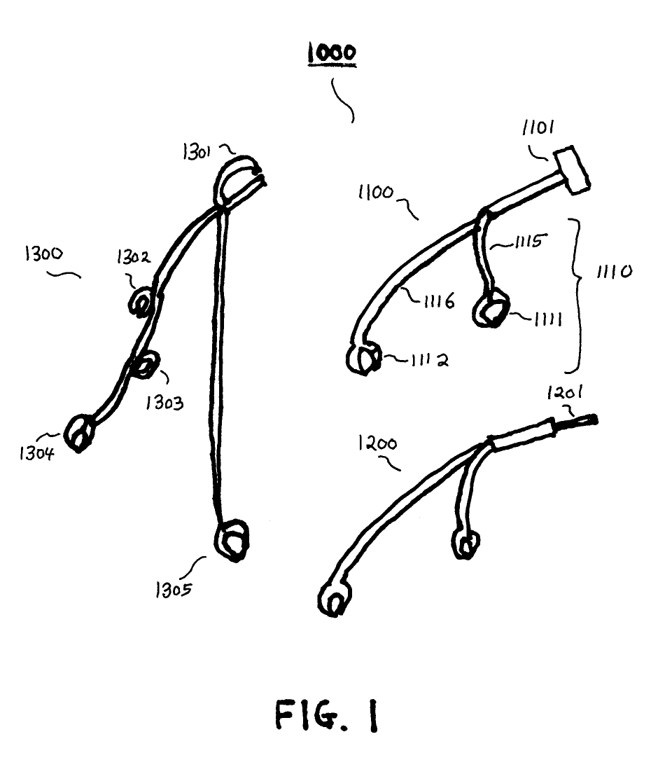

FIG. 1 depicts an apparatus 1000 including an apparatus 1100 including one or more tools 1101, wherein each one of the one or more tools, such as for example, a hammer, are connected to a shock absorbing member 1110, wherein the shock absorbing member 1110 includes a plurality of hooks 1111 and 1112. As another example, the tool could be a screwdriver 1201, as shown in apparatus 1200.

FIG. 1 further depicts an apparatus 1100 wherein the shock absorbing member 1110 comprises an exemplary two hooks 1111 and 1112. In this exemplary apparatus, the absorbing member 1110 further includes two portions 1115 and 1116, wherein the first one of the two portions 1115 is shorter than the second one of the two portions 1116. The first one of the two hooks 1111 is connected to the first one of the two portions 1115 and the second one of the two hooks 1112 is connected to the second one of the two portions 1116. In this exemplary embodiment, one of the one or more tools 1101 or 1201 may be connected, for example, on at least one of an end or along a length of the first one of the two portions 1110. The apparatus may also include a hoisting lanyard 1300, with a plurality of hooks, 1301, 1302, 1303, 1304, and 1305.

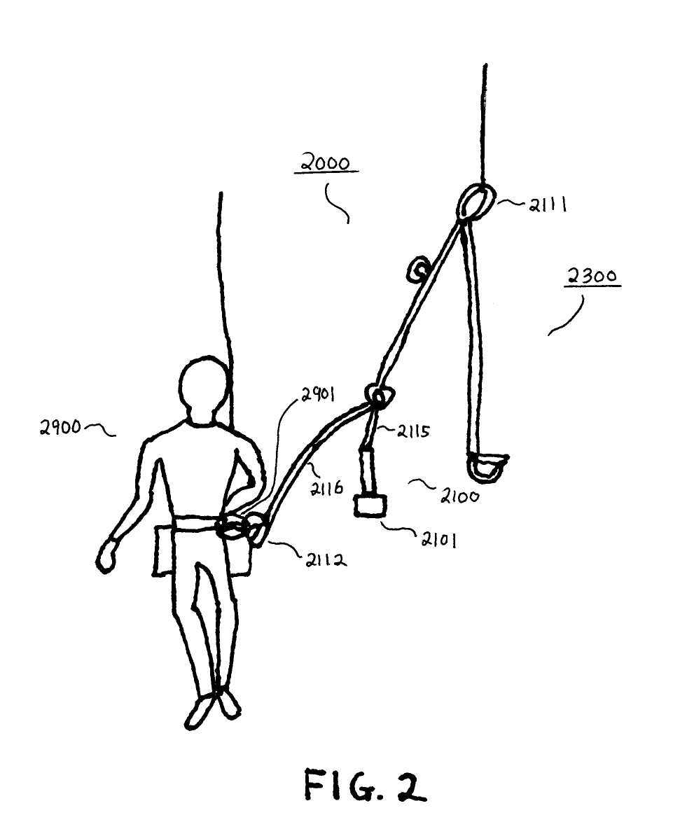

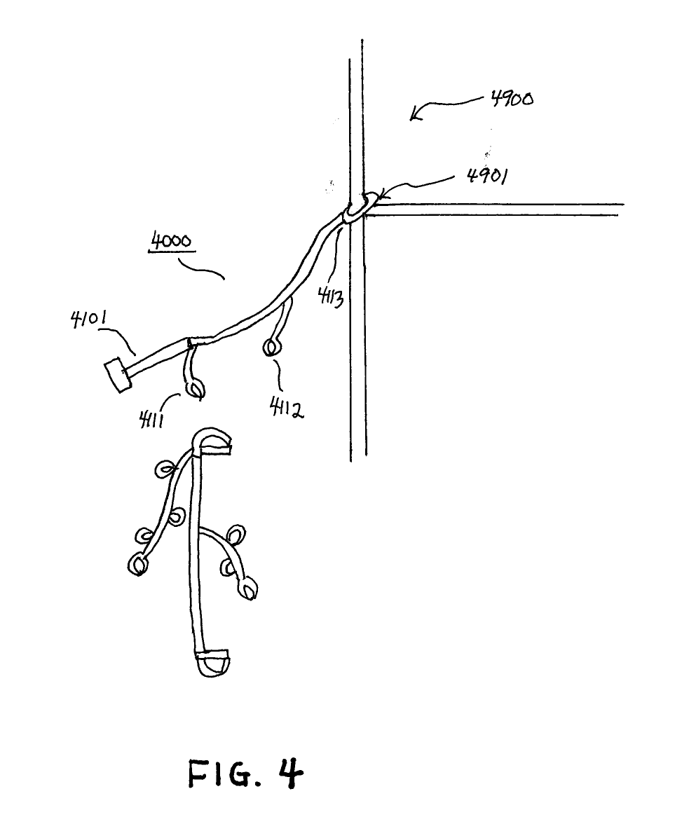

FIG. 2 further depicts an apparatus 2000 including a hoisting lanyard 2300 which is connected to an apparatus 2100. In this embodiment, the first hook 2111 is releasably connected to the hoisting lanyard 2300. Moreover, the second hook 2112 is releasably connected to at least one of an attachment point 2901 on a user 2900, such as a D-Ring on a belt worn by the user, or an alternate anchoring point. For example, the second hook 2112 may be connected to a work area 4900, as depicted in FIG. 4. In FIG. 4, the apparatus 4000 is connected to an anchoring point 4901 on the work area 4900 with hook 4113. The apparatus 4000 includes a tool 4101 and a plurality of hooks 4111, 4112, and 4113, as well as a hoisting lanyard.

The shock absorbing member could be formed by any material or in any configuration so as to allow the absorbing of shock, such as the force that would arise when a tool is dropped and the force is transferred to the attachment point or an anchoring point. Just as an example, the material could be made from a stretch material, wherein the stretch material is extendable when a force is applied. In operation, when a user 2900 attaches one of a plurality of tool connecting apparatus, such as 2100, to an attachment point on a user 2901, and the tool 2101 is dropped, the stretch material of apparatus 2100, which could be a stretch material forming 2116 and/or 2115, can extend itself so that a force applied to the attachment point 2901 when a respective one of the one or more tools 2101 is dropped is substantially minimized. The shock absorbing member could be made so that the force applied is substantially below the force likely to cause injury to a user.

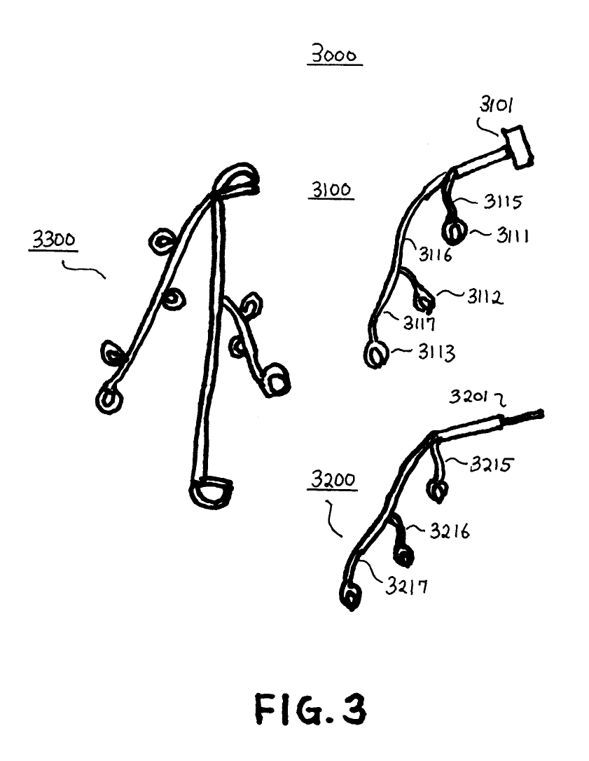

Of course, the number, the arrangement, the material, and other characteristics of the shock absorbing members can be varied as needed. Thus, for example, FIG. 3 depicts an apparatus 3000 in which apparatus 3101 includes three hooks 3111, 3112, and 3113. Moreover, the shock absorbing member 3100 may further include three portions 3115, 3116, and 3117, wherein a first one of the three portions 3115 is shorter than a second one of a three portions 3116 and a third one of the three portions 3117. Just an example, a first one of the three hooks 3111 is connected to the first one of the three portions 3115, a second one of the three hooks 3112 is connected to the second one of the three portions 3116, and a third one of the three hooks 3113 is connected to the third one of the three portions 3117. Thus, one of the one or more tools 3101 or 3201 may be connected on at least one of an end or along a length of the first one of the three portions 3115 or 3215, respectively. The apparatus 3000 may further include a hoisting lanyard 3300.

Thus, similar to the apparatus depicted in FIG. 2, the first hook 3113 may be releasably connected to the hoisting lanyard 3300. Either with or without the hoisting lanyard, as shown in FIG. 4, the second or third hook may be releasably connected to at least one of an attachment point on a user, as depicted in FIG. 2, or an anchoring point 4901, as depicted in FIG. 4. As noted above, the second hook may be releasably connected to at least one of a D-Ring connected to a user 2901 or a work area 4900 and its anchoring point 4901. Similar to the embodiment depicted in FIG. 1, the apparatus 3200 might be a another type of tool with a plurality of hooks and portions (e.g., 3215, 3216, and 3217).

In an exemplary operation, the apparatuses such as 1000, 2000, 3000, and 4000 depicted in FIG. 1-4, respectively, may comprise a set of apparatuses similar to apparatus 1100 which may, for example, have fourteen such apparatuses, including not just a hammer 1101 and a screwdriver 1201 but other tool types. Such a set of apparatuses is designed so as to eliminate the potential of dropping tools on other workers or equipment below. The apparatus or the toolkit permits 100% tie off of all the tools without interfering with a user's freedom of movement. The 100% tie-off means that at no point in the operation of the tools, will there be an instance where the tools are allowed to freely fall. They are always tied to an anchoring point. Each toolkit may, for example, be double tethered with 9800 polyester nylon webbing—forming, for example, the apparatus 1100 with portions 1115 and 1116—double stitched, and attached to 5000 pound double acting aluminum safety hooks, such as hooks 1111 and 1112 of FIG. 1. Alternatively, size, structure, strength, arrangement, and other characteristics of the hooks may be varied as needed. The toolkit may also include a bucket lanyard, which is formed so as to accommodate a bucket for hoisting parts or other items; multiple lanyard tools, in addition to the example of a hammer and screw described above; and a specially designed hoisting lanyard 1300 which permits the hoisting of all tools or a select group of tools. Of course, the specific number. shape, size, types, and other characteristics of the toolkit and its components may be varied as needed. The hoisting lanyard may be designed with staggered D-rings 1302, 1303, and 1304, which allows a worker or a user to select tools without tangling. The toolkit may come packed in its own dedicated and lockable tool box. Tools such as 1101 may be attached to the hoisting lanyard 1300 using the short lanyard 1115 connected to the tool. This leaves the long lanyard 1116 free so the worker can attach the long lanyard 1116 to the worker's belt D-ring 2901 or other suitable anchoring point, such as 4901. Once the worker has been safely hoisted into position to perform work, the tethered tools can be raised up to the worker, and after securing the tools, the worker can undertake the task at hand. In order to ensure 100% tie off, the worker selects the tool, for example 1101, that is needed and attaches the long lanyard 1116 of the tool, which should be hanging free, to the workers D-ring 2901, which for example may be located at his waist. Then the worker disconnects the short lanyard 1115 from the hoisting harness 1300. Without ever having been exposed to being dropped, the tool 1101 is now ready for use. Should the worker need to climb or to be raised higher, the worker can shorten the tool lanyard by clipping or attaching the short lanyard 1115 additionally to the worker's D-ring 2901 (which also has the long lanyard 1116 attached thereto). This takes up unnecessary length and allows the worker to move without tangling. After the worker's task is complete, the worker simply reverses the procedure by reattaching the short lanyard 1115 to the hoisting lanyard 1300. Since the D-rings 1302, 1303, and 1304 on the hoisting lanyard 1300 are staggered, tools can be reattached without the need to raise or lower the hoisting lanyard 1300. Once the short lanyard 1115 is attached to the hoisting lanyard 1300, the long lanyard 1116 can be released and the tools are ready to be lowered. Before storing, tools, lanyards, and hooks should all be rinsed thoroughly with fresh water to remove any damaging chemicals that may have come in contact with them. The toolkit may also include a parts list in the event that tools need to be replaced. In addition to having custom toolkits with a predetermined set of tools, special needs tethered tools can also be ordered. Also, the standard aluminum hooks may be substituted by hooks made with any other suitable material, as described above, including stainless steel.

Thus, the above detailed system prevents the dropping of one or more items such as 1100 and 1200, and includes a member 1100, wherein each one of the one or more items 1100 and 1200 are connected to the member 1100, wherein the member comprises a plurality of connectors, such as 1111 and 1112, wherein the member further comprises a plurality of portions, such as 1115 and 1116, wherein each one of the plurality of connectors 1111 and 1112 is connected to a respective one of the plurality of portions 1115 and 1116, and wherein each one of the one or more items such as 1100 is connected to an end of a respective one of the plurality of portions. Moreover, at least one of the plurality of connectors is continuously connected to at least one anchoring point so as to prevent the dropping of the one or more items. Stated another way, when one of the plurality of connectors is disconnected from the at least one anchoring point, at least one other one of the plurality of the connectors is still connected to an anchoring point. The anchoring point may be a point which provides support for the connectors so that the apparatus is not dropped below and includes, without limitation, an attachment point on a user, a D-Ring connected to a user, a work area, and a hoisting lanyard.

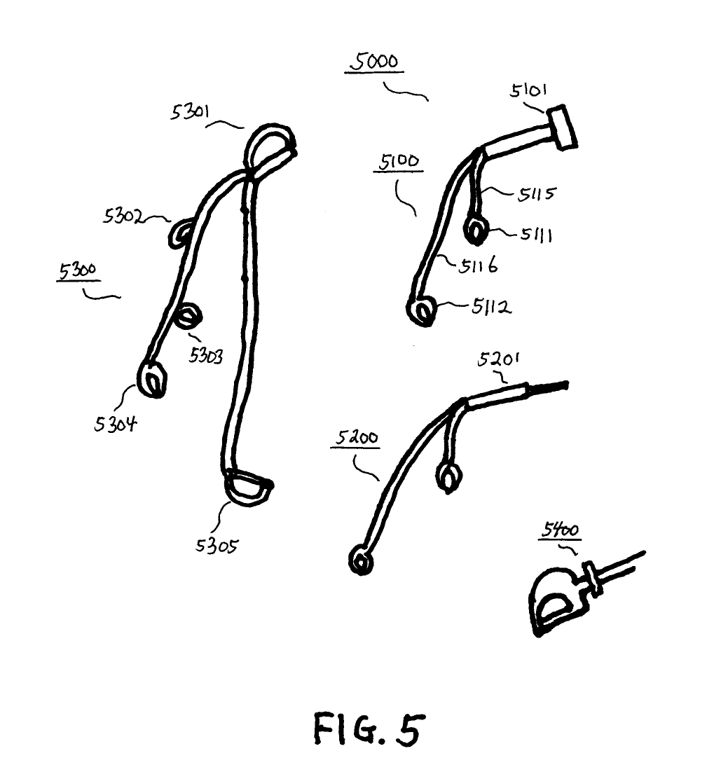

FIG. 5 depicts an apparatus 5000 including one or more tools such as 5101 and 5201, wherein each one of the one or more tools are connected to a water-proof shock-absorbing member forming the portions 5115 and 5116, wherein the member comprises two self-locking swivel hooks 5111 and 5112. The water-proof material provides an additional safety feature whose benefits includes, but is not limited to, better gripping surface in the context of an outside work environment where wetness may be present. The swivel hooks aid in usability and ease of handling in terms of freedom of movement, especially in work areas where space is a premium. The size, arrangement, structure, shape, and other characteristics of the water-proof shock-absorbing member and the hooks may be varied as needed. Thus, self-locking hook 5131 is attached to a swivel mechanism 5121 to form 5111. As an example, the tool could be a hammer or a screwdriver, as shown in apparatuses 5100 and 5200, respectively.

FIG. 5 further depicts an apparatus 5100 wherein the water-proof shock absorbing member 5110 comprises an exemplary two self-locking swivel hooks 5111 and 5112. In this exemplary apparatus, the water-proof shock absorbing member 5110 further includes two portions 5115 and 5116, wherein the first one of the two portions 5115 is shorter than the second one of the two portions 5116. The first one of the two hooks 5111 is connected to the first one of the two portions 5115 and the second one of the two hooks 5112 is connected to the second one of the two portions 5116. In this exemplary embodiment, one of the one or more tools 5101 or 5201 may be connected, for example, on at least one of an end or along a length of the first one of the two portions 5110. The apparatus may also include a hoisting lanyard 5300, with a plurality of hooks 5301, 5302, 5303, 5304, and 5305.

This embodiment can be used similar to the above described embodiment with respect to FIG. 2. Thus, an exemplary embodiment may be provided in which a hoisting lanyard 5300 is connected to an apparatus 5100. In this embodiment, the first hook 5111 is releasably connected to the hoisting lanyard 5300. Moreover, the second hook 5112 is releasably connected to at least one of an attachment point on a user or an anchoring point 2901. Alternatively, the second hook 5112 may be connected to a work area 4900, as depicted in FIG. 4. Again, the shock absorbing member could be formed by any material or in any configuration so as to allow the absorbing of shock, such as the force that would arise when a tool is dropped and the force is transferred to the attachment point or an anchoring point. Similar to the above described embodiment, the material could be made from a stretch material, wherein the stretch material is extendable when a force is applied. In operation, when a user 2900 attaches one of a plurality of tool connecting apparatus, such as 5100, to an attachment point on a user 2901, and the tool 5101 is dropped, the stretch material of apparatus 5100, which could be a stretch material forming 5116 and/or 5115, can extend itself so that a force applied to the attachment point 5901 when a respective one of the one or more tools 5101 is dropped is substantially minimized. The shock absorbing member could be made so that the force applied is substantially below the force likely to cause injury to a user.

Of course, the number, shape, size, arrangement, and other characteristics of the shock absorbing members can be varied as needed. Thus, similar to the above description for FIG. 3, this embodiment may also have more than two hooks, with a respective number of portions. Also, the shock absorbing member may further include three portions, wherein a first one of the three portions is shorter than a second one of a three portions and a third one of the three portions. Just an example, a first one of the three hooks may be connected to the first one of the three portions, a second one of the three hooks may be connected to the second one of the three portions, and a third one of the three hooks may be connected to the third one of the three portions. Thus, one of the one or more tools may be connected on at least one of an end or along a length of the first one of the three portions, respectively. The apparatus may further include a hoisting lanyard.

Again, similar to the apparatus depicted in FIG. 2, the first hook 5111 may be releasably connected to the hoisting lanyard 5300. Either with or without the hoisting lanyard, as shown in FIG. 4. the second or third hook 5112 may be releasably connected to at least one of an attachment point on a user, as depicted in FIG. 2, or an anchoring point 4901, as depicted in FIG. 4. As noted above, the second hook may be releasably connected to at least one of a D-Ring connected to a user 2901 or a work area 4900 and its anchoring point 4901.

Similar to the earlier described embodiment, in an exemplary operation, the set of apparatuses of this embodiment is designed so as to eliminate the potential of dropping tools on other workers or equipment below. Again, the apparatus or the toolkit permits 100% tie off of all the tools without interfering with a user's freedom of movement. The 100% tie-off means that at no point in the operation of the tools, will there be an instance where the tools are allowed to freely fall. They are always tied to an anchoring point. Each toolkit item may, for example, be double tethered with waterproof webbing attached to swivel hooks. The toolkit may also include a bucket lanyard for hoisting parts or other items, multiple lanyard tools, and an especially designed hoisting lanyard which permits the hoisting of all tools or a select group of tools. The hoisting lanyard is designed with staggered D-rings, and 5302, 5303, and 5304, which allow a worker or a user to select tools without tangling. The toolkit may come packed in its own dedicated and lockable tool box. Tools such as 5101 may be attached to the hoisting lanyard 5300 using the short lanyard 5115 connected to the tool. This leaves the long lanyard 5116 free so the worker can attach the long lanyard 5116 to the worker's belt D-ring 5901 or other suitable anchoring point, such as 4901, as depicted in FIG. 4. Once the worker has been safely hoisted into position to perform work, the tethered tools can be raised up to the worker, and after securing the tools, the worker can undertake the task at hand. In order to ensure 100% tie off, the worker selects the tool, for example 5101, that is needed and attaches the long lanyard 5116 of the tool, which should be hanging free, to the workers D-ring 2901, as depicted in FIG. 2, which for example may be located at his waist. Then the worker disconnects the short lanyard 5115 from the hoisting harness 5300. Without ever having been exposed to being dropped, the tool 5101 is now ready for use. Should the worker need to climb or to be raised higher, the worker can shorten the tool lanyard by clipping or attaching the short lanyard 5115 also to the worker's D-ring 2901 (which also has the long lanyard 51.16 attached thereto). This takes up unnecessary length and allows the worker to move without tangling. After the worker's task is complete, the worker simply reverses the procedure by reattaching the short lanyard 5115 to the hoisting lanyard 5300. Since the D-rings 5302, 5303, and 5304 on the hoisting lanyard 5300 are staggered, tools can be reattached without the need to raise or lower the hoisting lanyard 5300. Once the short lanyard 5115 is attached to the hoisting lanyard 5300, the long lanyard 5116 can be released and the tools are ready to be lowered. Before storing, tools, lanyards, and hooks should all be rinsed thoroughly with fresh water to remove any damaging chemicals that may have come in contact with them. The toolkit may also include a parts list in the event that tools need to be replaced. In addition to having custom toolkits with a predetermined set of tools, special needs tethered tools can also be ordered. Also, the standard aluminum hooks may be substituted by hooks made with any other suitable material, including stainless steel.

Thus, the above described system prevents the dropping of one or more items such as 5101 and 5201, and includes a member 5100, wherein each one of the one or more items 5101 and 5201 are connected to the member 5100, wherein the member comprises a plurality of connectors, such as 5111 and 5112, wherein the member further comprises a plurality of portions, such as 5115 and 5116, wherein each one of the plurality of connectors 5111 and 5112 is connected to a respective one of the plurality of portions 5115 and 5116, and wherein each one of the one or more items such as 5100 is connected to an end of a respective one of the plurality of portions. Moreover, at least one of the plurality of connectors is continuously connected to at least one anchoring point so as to prevent the dropping of the one or more items. Stated another way, when one of the plurality of connectors is disconnected from the at least one anchoring point, at least one other one of the plurality of the connectors is still connected to an anchoring point. The anchoring point may be a point which provides support for the connectors so that the apparatus is not dropped below and includes, without limitation, an attachment point on a user, a D-Ring connected to a user, a work area, and a hoisting lanyard.

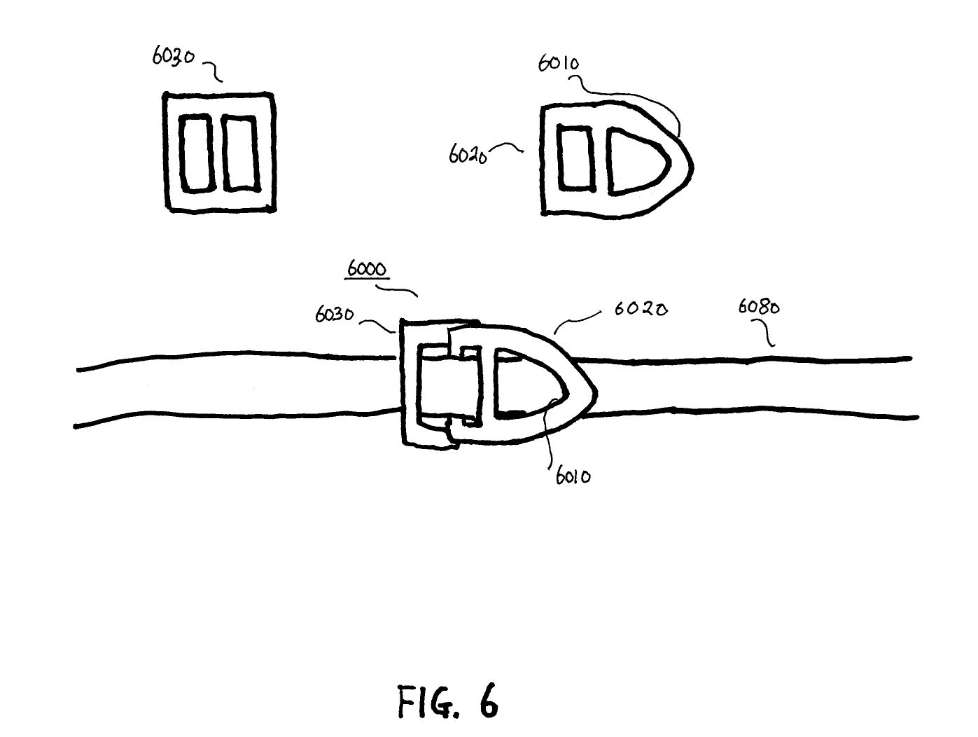

As depicted in FIG. 6, in another embodiment of the invention, a tie back member 6000 can further be used to connect the hoisting member to an anchoring point. The tie back member 6000 may include a sliding portion 6030, wherein the sliding portion 6030 slides along a length of the hoisting member 6080, and a connecting portion 6020, wherein the connecting portion 6020, using the attaching portion 6010, may be used to connect the hoisting member to an anchoring point. Of course, the shape, size, material, and other characteristics of the attaching portion 6010 may be varied as needed.

Thus in this embodiment, similar to the above described other embodiments, the apparatus includes one or more tools, wherein the one or more tools comprises one or more tool connecting members; and a hoisting member, wherein the hoisting member comprises one or more hoisting connecting portions, wherein the hoisting member can be used to raise the one or more tools by connecting a respective one of the one or more tool connecting members to at least one of the one or more hoisting connecting portions; and wherein the one or more tools is continuously connected to at least one tie-off point so that when any one of the one or more tool connecting members is disconnected to use a respective one of the one or more tools, at least another one of the one or more tool connecting members remains connected to the tie-off point.

As exemplified in FIG. 6, the sliding portion 6030 and the connecting portion 6020 cooperate to exert a releasable immobilizing pressure on the hoisting member 6080, wherein the releasable immobilizing pressure prevents the sliding portion 6030 and the connecting portion 6020 from sliding along the hoisting member 6080.

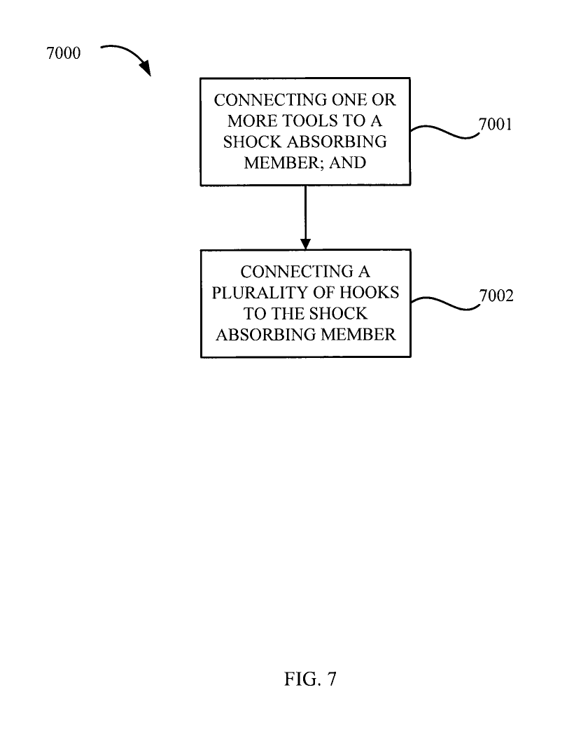

FIG. 7 depicts an exemplary method 7000 according to the present invention, including the steps of connecting one or more tools to a shock absorbing member at 7001; and connecting a plurality of hooks to the shock absorbing member at 7002. As exemplified already with respect to the above described embodiments, tools may be connected to a shock absorbing member so that when the shock absorbing member is attached to an anchoring point, such as a D-Ring on a user, less force is transmitted to the anchoring point when the tool is dropped by a user working, for example, high up in the air. As exemplified above, the plurality of hooks allows the ensuring of 100% tie-off at all times when the one or more tools are being used in the air. Thus, as explained above, one of the hooks may, for example, be connected to a hoisting harness and may be brought up near a user located up in the air by raising the hoisting harness. Then, a user could take another hook connected to the shock absorbing member and attach this second hook to an anchoring point on the user or on a secure worksite. Now, the user can safely release the first hook attached to the hoisting harness and use the tool—never exposing the tool to the possibility of dropping freely onto the surface lying below, and thus ensuring a 100% tie-off use of the tool.

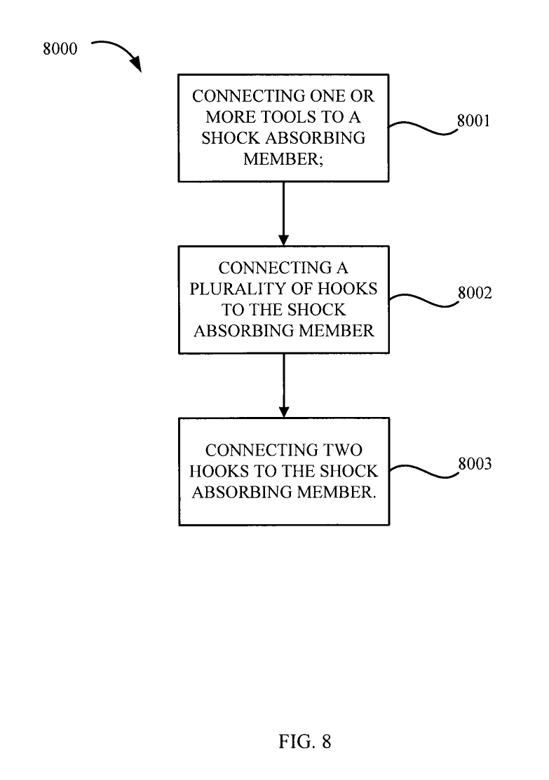

FIG. 8 depicts an exemplary method 8000, including connecting one or more tools to a shock absorbing member at 8001; connecting a plurality of hooks to the shock absorbing member at 8002, wherein the plurality of hooks may, more specifically, include two hooks at 8003. There could, of course, be more than two hooks when such additional hooks are helpful or needed, but in this exemplary embodiment, two hooks may be used. As described in the preceding paragraph, at least one of the two hooks may be connected to a hoisting harness or an anchoring point continuously so as to ensure a 100% tie off.

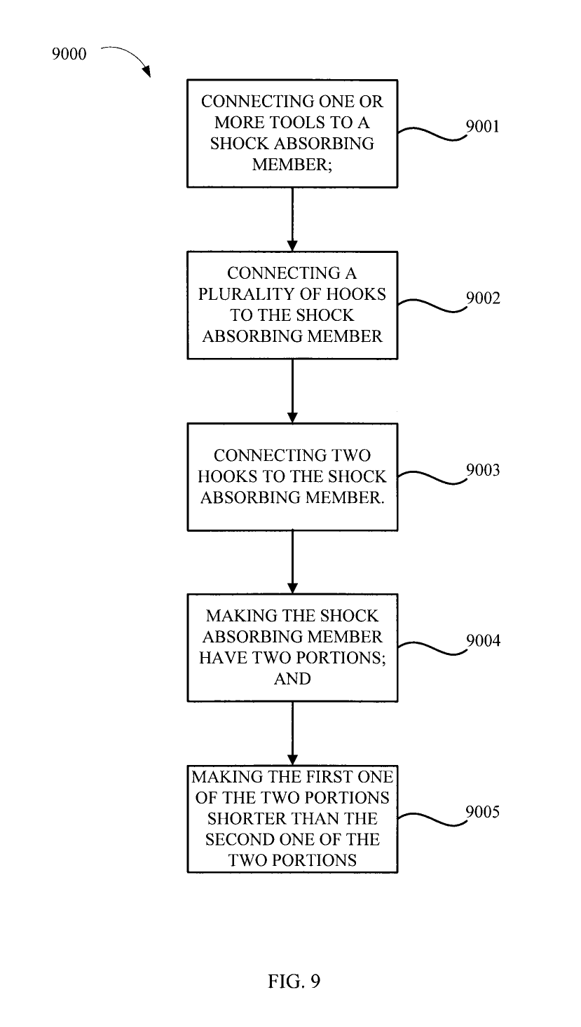

FIG. 9 depicts a method 9000, including connecting one or more tools to a shock absorbing member at 9001; connecting a plurality of hooks to the shock absorbing member at 9002; wherein the plurality of hooks may, more specifically, include two hooks to the shock absorbing member at 9003; making the shock absorbing member have two portions at 9004; and making a first one of the two portions shorter than a second one of the two portions at 9005.

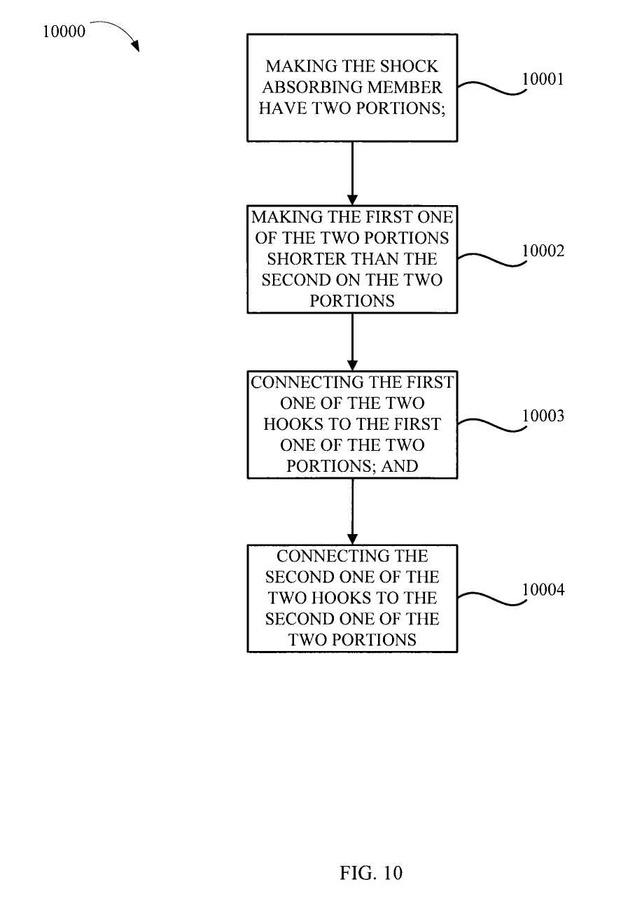

FIG. 10 depicts a method 10000, following steps 9001-9003 depicted in FIG. 9 of connecting one or more tools to a shock absorbing member 9001; connecting a plurality of hooks to the shock absorbing member 9002; and connecting two hooks to the shock absorbing member 9003. Thereafter, this embodiment includes making the shock absorbing member have two portions at 10001; making a first one of the two portions shorter than a second one of the two portions at 10002; and includes the additional steps of connecting the first one of the two hooks to the first one of the two portions 10003; and connecting the second one of the two hooks to the second one of the two portions 10004.

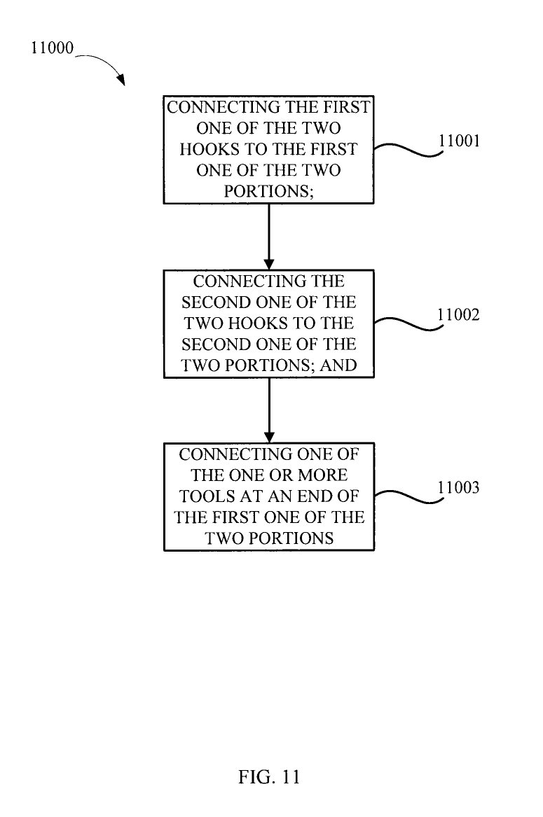

FIG. 11 depicts a method 11000, including steps depicted in FIGS. 9 and 10 of connecting one or more tools to a shock absorbing member; connecting a plurality of hooks to the shock absorbing member; connecting two hooks to the shock absorbing member; making the shock absorbing member have two portions; and making a first one of the two portions shorter than a second one of the two portions, connecting the first one of the two hooks to the first one of the two portions (also at 11001); and connecting the second one of the two hooks to the second one of the two portions (also at 11002); with the additional step of connecting one of the one or more tools on at least one of an end or along a length of the first one of the two portions at 11003.

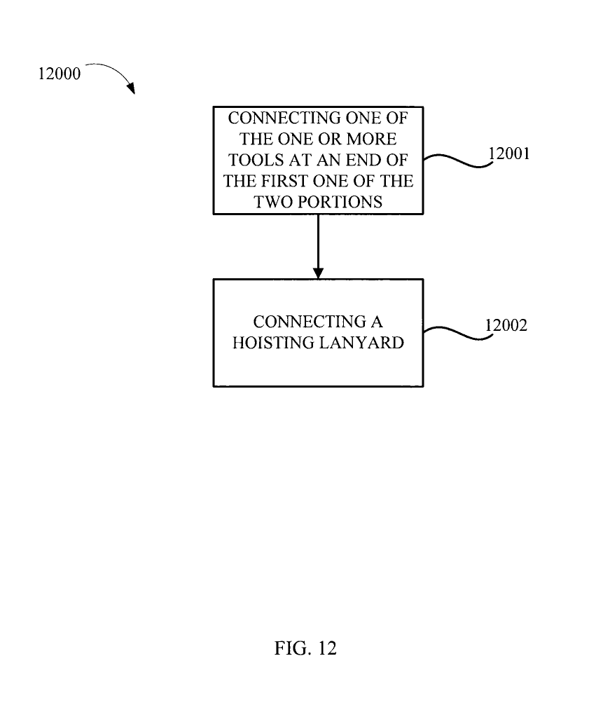

FIG. 12 depicts a method 12000, including steps depicted in FIGS. 9-11 of connecting one or more tools to a shock absorbing member; connecting a plurality of hooks to the shock absorbing member; connecting two hooks to the shock absorbing member; making the shock absorbing member have two portions; making a first one of the two portions shorter than a second one of the two portions, connecting the first one of the two hooks to the first one of the two portions; connecting the second one of the two hooks to the second one of the two portions; and connecting one of the one or more tools on at least one of an end or along a length of the first one of the two portions (also at 12001); with the additional step of connecting a hoisting lanyard at 12002.

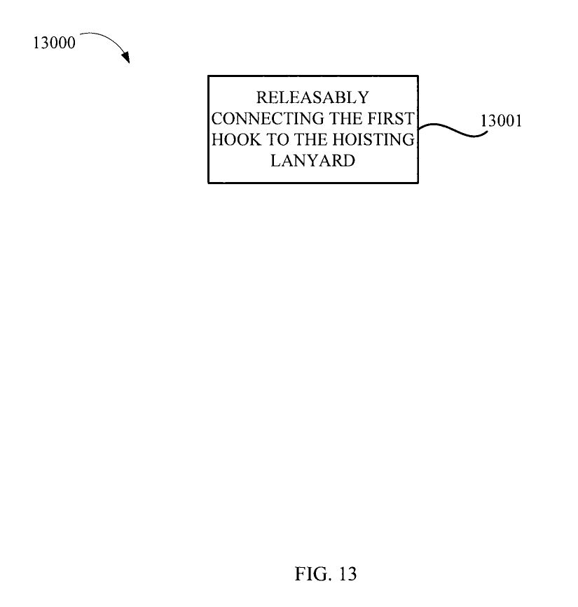

FIG. 13 depicts a method 13000, including steps depicted in FIGS. 9-12 of connecting one or more tools to a shock absorbing member; connecting a plurality of hooks to the shock absorbing member; connecting two hooks to the shock absorbing member; making the shock absorbing member have two portions; making a first one of the two portions shorter than a second one of the two portions, connecting the first one of the two hooks to the first one of the two portions at; connecting the second one of the two hooks to the second one of the two portions; connecting one of the one or more tools on at least one of an end or along a length of the first one of the two portions; and connecting a hoisting lanyard; with the additional step of releasably connecting the first hook to the hoisting lanyard at step 13001.

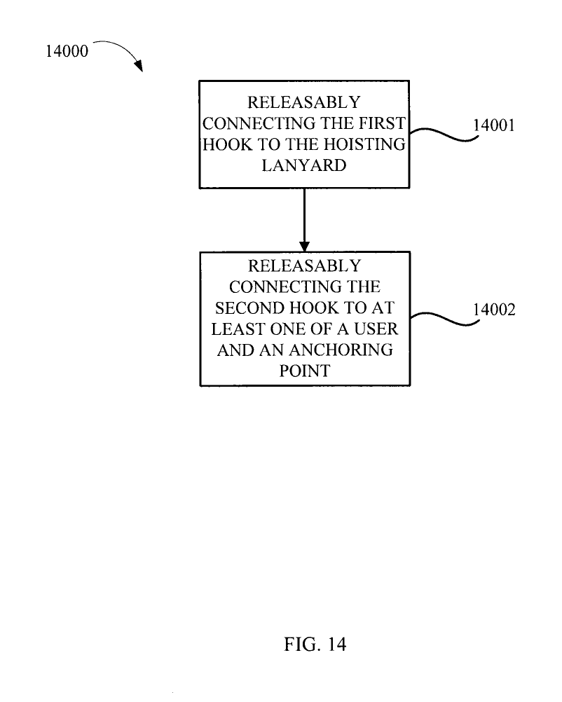

FIG. 14 depicts a method 14000, including steps depicted in FIGS. 9-13 of connecting one or more tools to a shock absorbing member; connecting a plurality of hooks to the shock absorbing member; connecting two hooks to the shock absorbing member; making the shock absorbing member have two portions; making a first one of the two portions shorter than a second one of the two portions, connecting the first one of the two hooks to the first one of the two portions at; connecting the second one of the two hooks to the second one of the two portions; connecting one of the one or more tools on at least one of an end or along a length of the first one of the two portions; connecting a hoisting lanyard; and releasably connecting the first hook to the hoisting lanyard (also at 14001); with step of releasably connecting the second hook to at least one of an attachment point on a user and an anchoring point at step 14002.

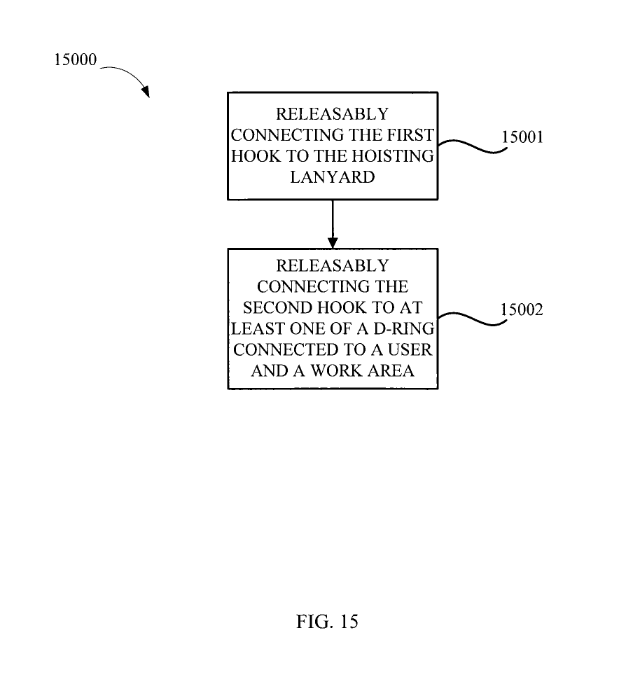

FIG. 15 depicts a method 15000, including steps depicted in FIGS. 9-14 of connecting one or more tools to a shock absorbing member; connecting a plurality of hooks to the shock absorbing member; connecting two hooks to the shock absorbing member; making the shock absorbing member have two portions; making a first one of the two portions shorter than a second one of the two portions, connecting the first one of the two hooks to the first one of the two portions at; connecting the second one of the two hooks to the second one of the two portions; connecting one of the one or more tools on at least one of an end or along a length of the first one of the two portions; connecting a hoisting lanyard; and releasably connecting the first hook to the hoisting lanyard (also at 15001); with the step of releasably connecting the second hook to at least one of a D-Ring connected to a user and a work area at 15002.

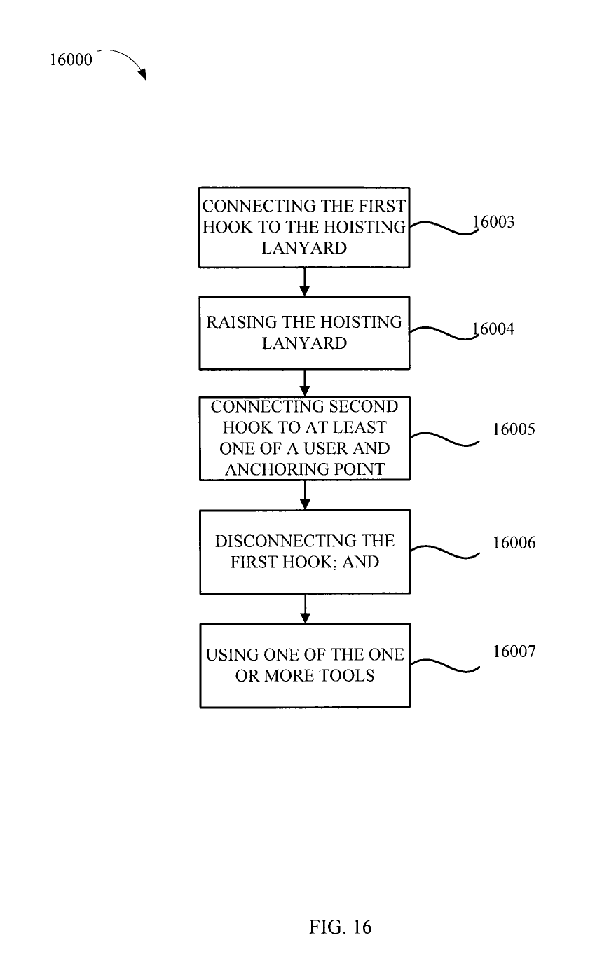

FIG. 16 depicts a method 16000, including steps depicted in FIGS. 9-12 of connecting one or more tools to a shock absorbing member; connecting a plurality of hooks to the shock absorbing member; connecting two hooks to the shock absorbing member; making the shock absorbing member have two portions; making a first one of the two portions shorter than a second one of the two portions, connecting the first one of the two hooks to the first one of the two portions at; connecting the second one of the two hooks to the second one of the two portions; connecting one of the one or more tools on at least one of an end or along a length of the first one of the two portions; connecting a hoisting lanyard; with the additional steps of connecting the first hook to the hoisting lanyard; raising the hoisting lanyard; connecting the second hook to the at least one of a user and an anchoring point; disconnecting the first hook; and using one of the one or more tools.

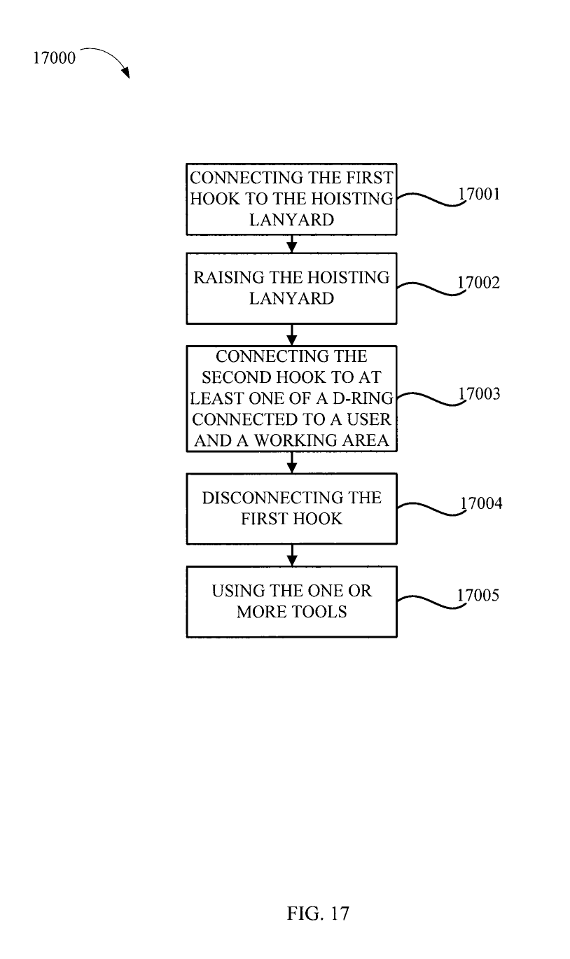

FIG. 17 depicts a method 17000, including steps depicted in FIGS. 9-12 of connecting one or more tools to a shock absorbing member; connecting a plurality of hooks to the shock absorbing member; connecting two hooks to the shock absorbing member; making the shock absorbing member have two portions; making a first one of the two portions shorter than a second one of the two portions, connecting the first one of the two hooks to the first one of the two portions at; connecting the second one of the two hooks to the second one of the two portions; connecting one of the one or more tools on at least one of an end or along a length of the first one of the two portions; connecting a hoisting lanyard at 12002; with the additional steps of connecting the first hook to the hoisting lanyard; raising the hoisting lanyard; connecting the second hook to the at least one of a D-Ring connected to a user and a work area; disconnecting first second hook; and using one of the one or more tools.

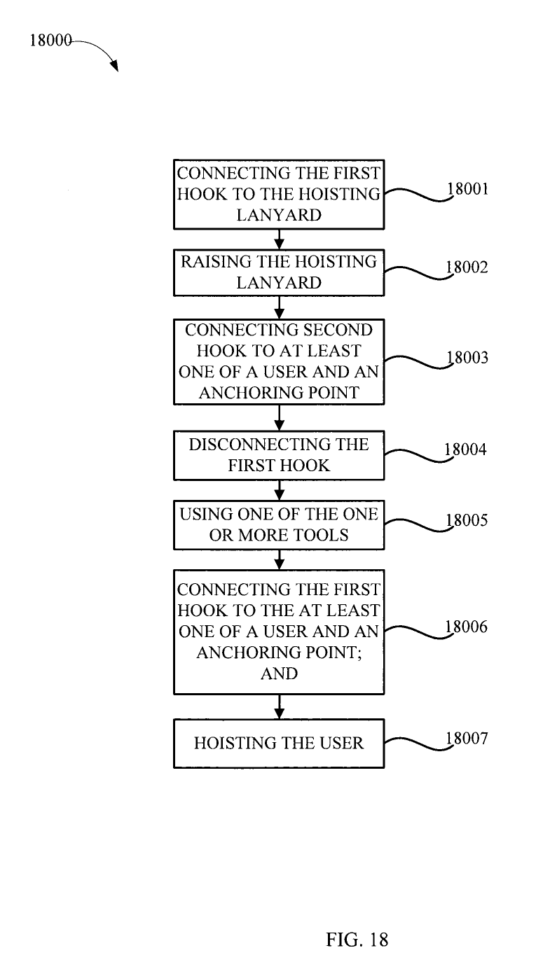

FIG. 18 depicts a method 18000, including steps depicted in FIGS. 9-14 of connecting one or more tools to a shock absorbing member; connecting a plurality of hooks to the shock absorbing member; connecting two hooks to the shock absorbing member; making the shock absorbing member have two portions; making a first one of the two portions shorter than a second one of the two portions, connecting the first one of the two hooks to the first one of the two portions at; connecting the second one of the two hooks to the second one of the two portions; connecting one of the one or more tools on at least one of an end or along a length of the first one of the two portions; connecting a hoisting lanyard; releasably connecting the first hook to the hoisting lanyard; and releasably connecting the second hook to at least one of an attachment point on a user and an anchoring point; with the additional steps of connecting the first hook to the hoisting lanyard; raising the hoisting lanyard; connecting the second hook to the at least one of a user and an anchoring point; disconnecting the first hook; using one of the one or more tools; connecting the first hook to the at least one of a user and an anchoring point; and hoisting the user.

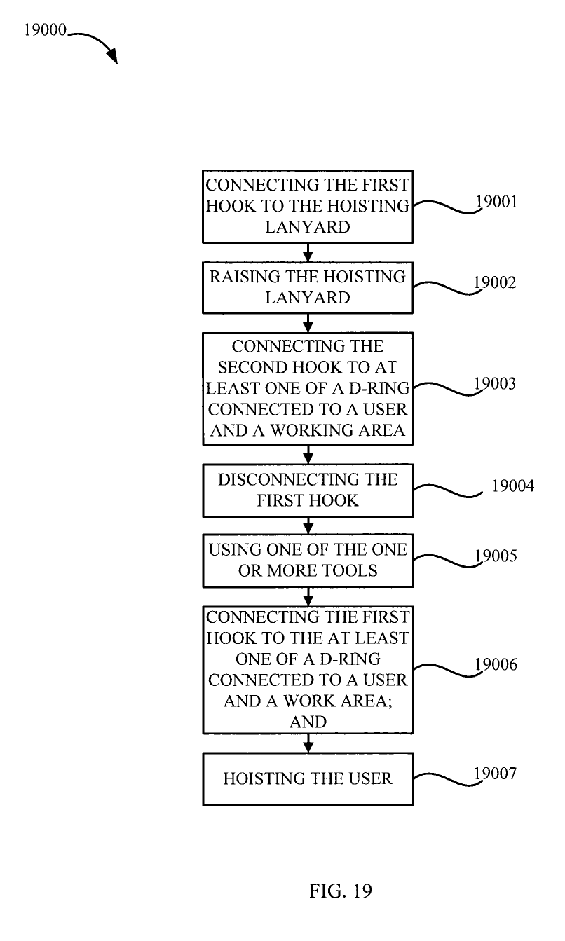

FIG. 19 depicts a method 19000, including steps depicted in FIGS. 9-13 and 15 of connecting one or more tools to a shock absorbing member; connecting a plurality of hooks to the shock absorbing member; connecting two hooks to the shock absorbing member; making the shock absorbing member have two portions; making a first one of the two portions shorter than a second one of the two portions, connecting the first one of the two hooks to the first one of the two portions; connecting the second one of the two hooks to the second one of the two portions; connecting one of the one or more tools on at least one of an end or along a length of the first one of the two portions; connecting a hoisting lanyard; releasably connecting the first hook to the hoisting lanyard; and releasably connecting the second hook to at least one of a D-Ring connected to a user and a work area; with the additional steps of connecting the first hook to the hoisting lanyard; raising the hoisting lanyard; connecting the second hook to the at least one of a D-Ring connected to a user and a work area; disconnecting the first hook; using one of the one or more tools; connecting the first hook to the at least one of a user and an anchoring point; and hoisting the user.

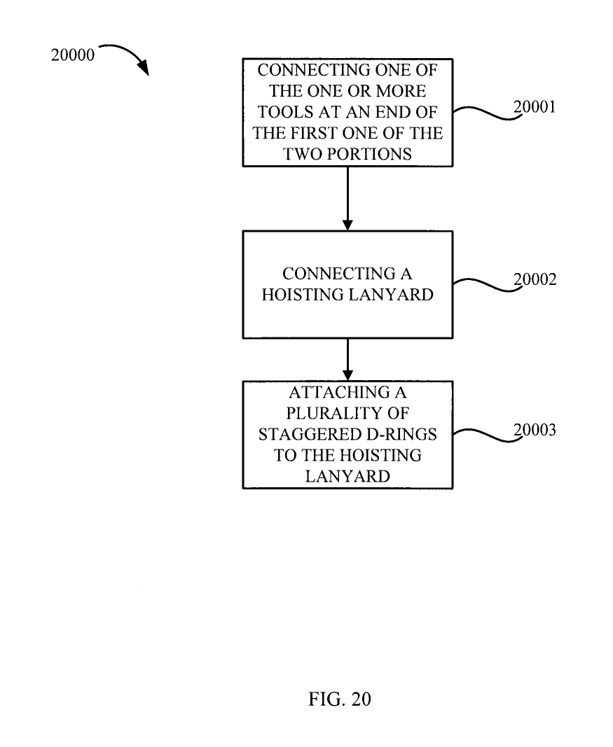

FIG. 20 depicts a method 20000, including steps depicted in the above described FIGS. of connecting one or more tools to a shock absorbing member; connecting a plurality of hooks to the shock absorbing member; connecting two hooks to the shock absorbing member; making the shock absorbing member have two portions; and making a first one of the two portions shorter than a second one of the two portions, connecting the first one of the two hooks to the first one of the two portions at; connecting the second one of the two hooks to the second one of the two portions; and connecting one of the one or more tools on at least one of an end or along a length of the first one of the two portions; with the additional step of providing on the hoisting lanyard a plurality of staggered D-Rings.

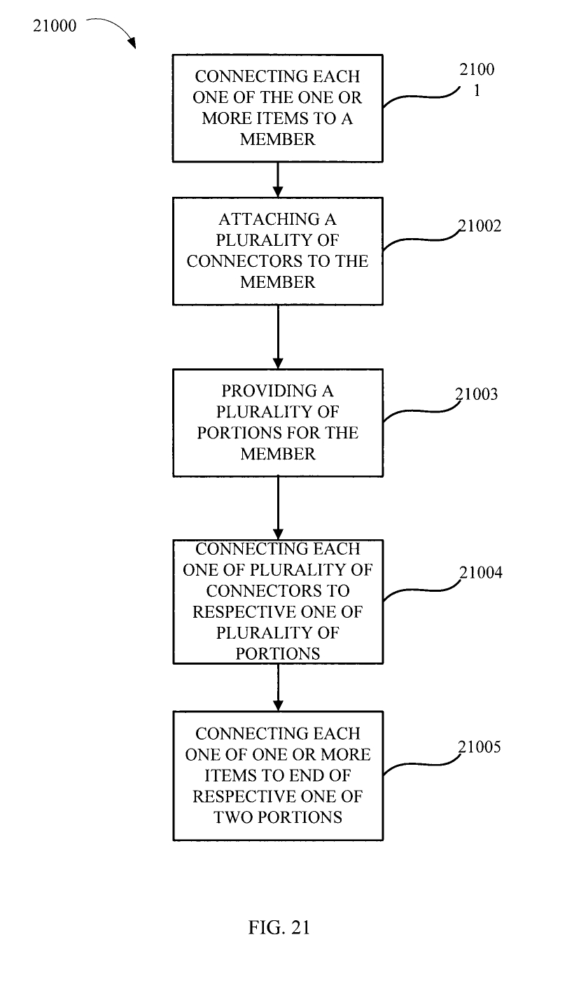

FIG. 21 depicts a method 21000 for preventing the dropping of one or more items, including the steps of connecting each one of the one or more items to a member; attaching a plurality of connectors to the member; providing a plurality of portions for the member; connecting each one of the plurality of connectors to a respective one of the plurality of portions; and connecting each one of the one or more items to an end of a respective one of the two portions.

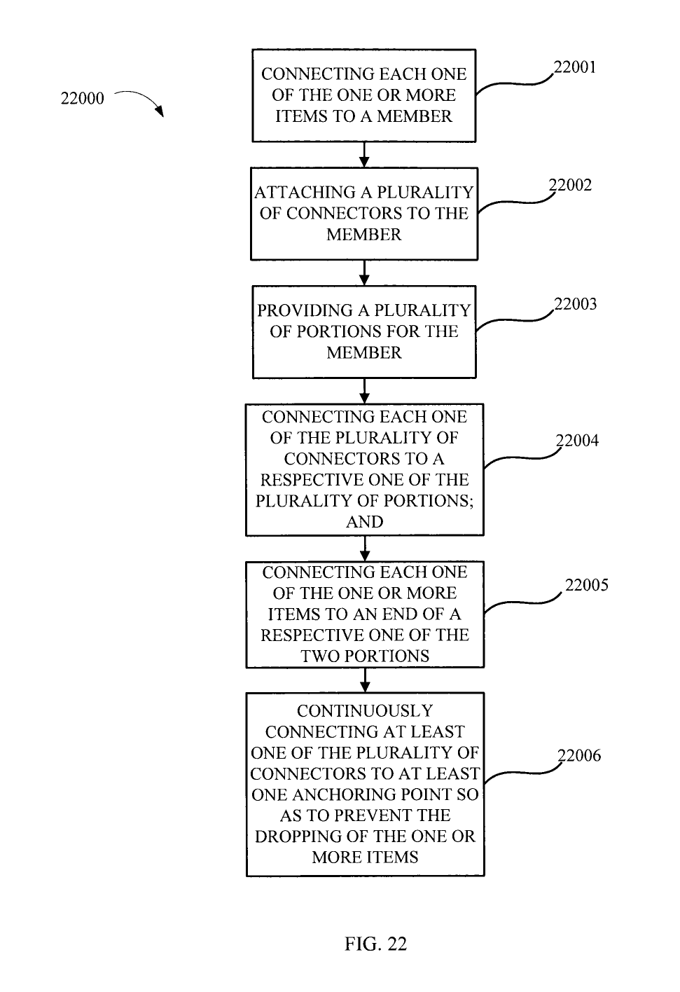

FIG. 22 depicts a method 22000 for preventing the dropping of one or more items, including the steps of connecting each one of the one or more items to a member; attaching a plurality of connectors to the member; providing a plurality of portions for the member; connecting each one of the plurality of connectors to a respective one of the plurality of portions; connecting each one of the one or more items to an end of a respective one of the two portions; and continuously connecting at least one of the plurality of connectors to at least one anchoring point so as to prevent the dropping of the one or more items.

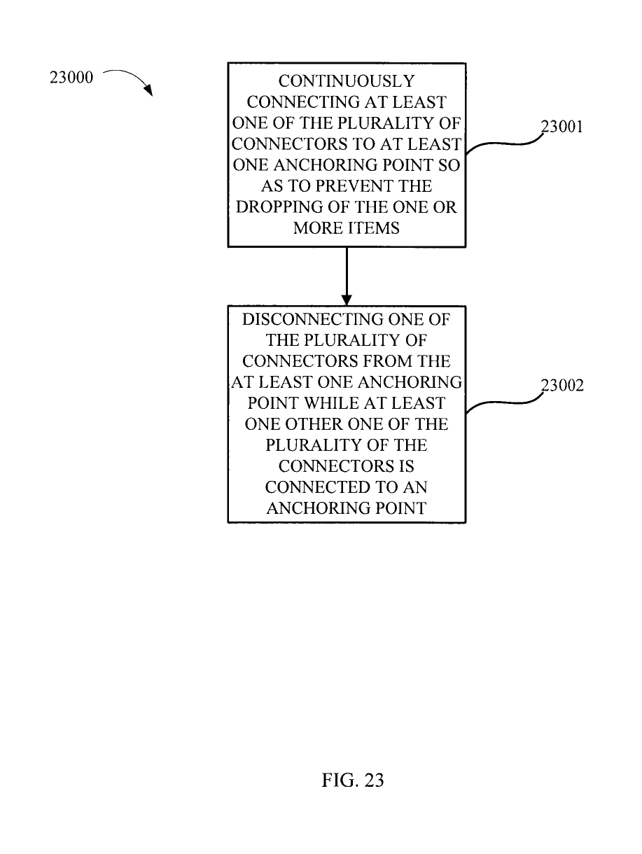

FIG. 23 depicts a method 23000 for preventing the dropping of one or more items, including the steps depicted in the above described FIGS. of connecting each one of the one or more items to a member; attaching a plurality of connectors to the member; providing a plurality of portions for the member; connecting each one of the plurality of connectors to a respective one of the plurality of portions; connecting each one of the one or more items to an end of a respective one of the two portions; and continuously connecting at least one of the plurality of connectors to at least one anchoring point so as to prevent the dropping of the one or more items; further including disconnecting one of the plurality of connectors from the at least one anchoring point while at least one other one of the plurality of the connectors is connected to an anchoring point.

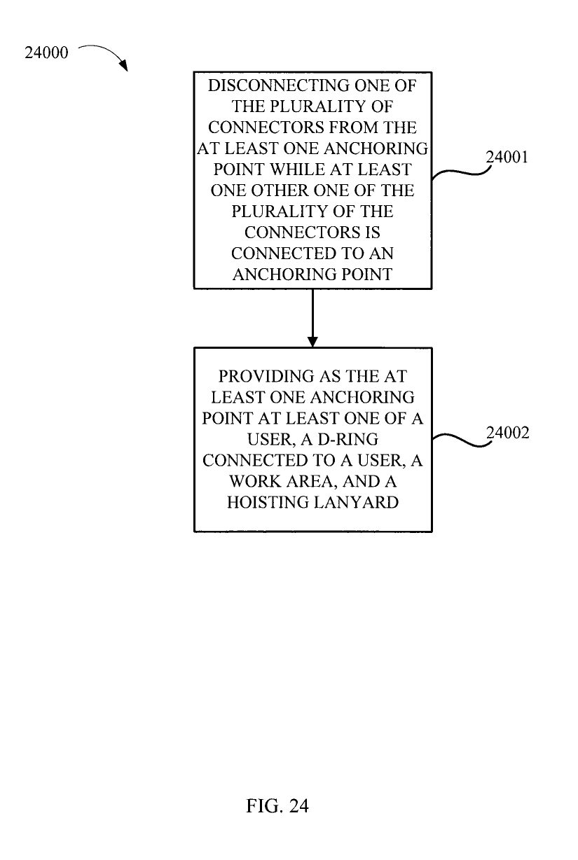

FIG. 24 depicts a method 24000 for preventing the dropping of one or more items, including the steps depicted in the above described FIGS. of connecting each one of the one or more items to a member; attaching a plurality of connectors to the member; providing a plurality of portions for the member; connecting each one of the plurality of connectors to a respective one of the plurality of portions; connecting each one of the one or more items to an end of a respective one of the two portions; continuously connecting at least one of the plurality of connectors to at least one anchoring point so as to prevent the dropping of the one or more items; disconnecting one of the plurality of connectors from the at least one anchoring point while at least one other one of the plurality of the connectors is connected to an anchoring point; and further including providing as the at least one anchoring point at least one of a user, a D-Ring connected to a user, a work area, and a hoisting lanyard.

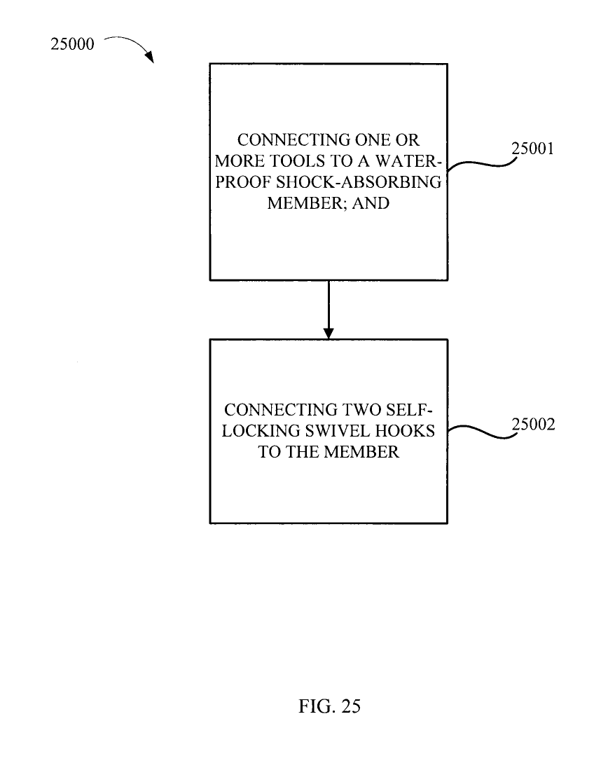

FIG. 25 depicts a method 25000, including connecting one or more tools to a water-proof shock-absorbing member; and connecting two self-locking swivel hooks to the member.

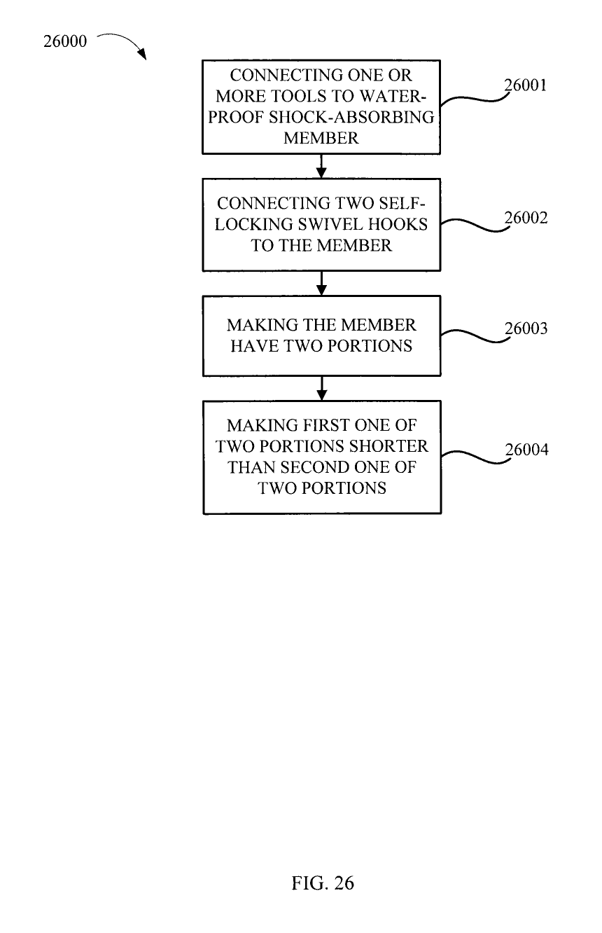

FIG. 26 depicts a method 26000, including connecting one or more tools to a water-proof shock-absorbing member; and connecting two self-locking swivel hooks to the member, further including making the member have two portions; and making a first one of the two portions shorter than a second on the two portions.

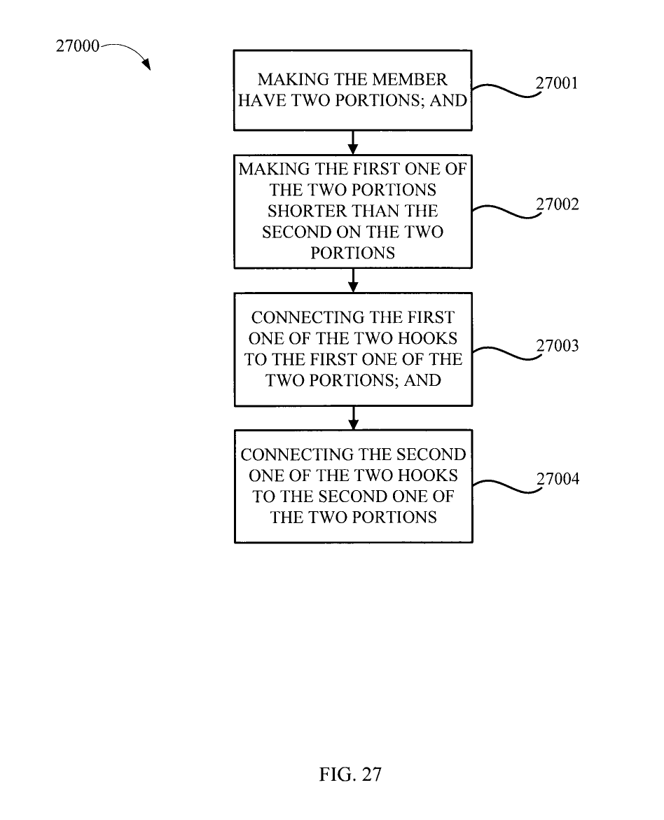

FIG. 27 depicts a method 27000, including the above described steps of connecting one or more tools to a water-proof shock-absorbing member; connecting two self-locking swivel hooks to the member, making the member have two portions; making a first one of the two portions shorter than a second on the two portions, and further including connecting a first one of the two hooks to the first one of the two portions; and connecting a second one of the two hooks to the second one of the two portions.

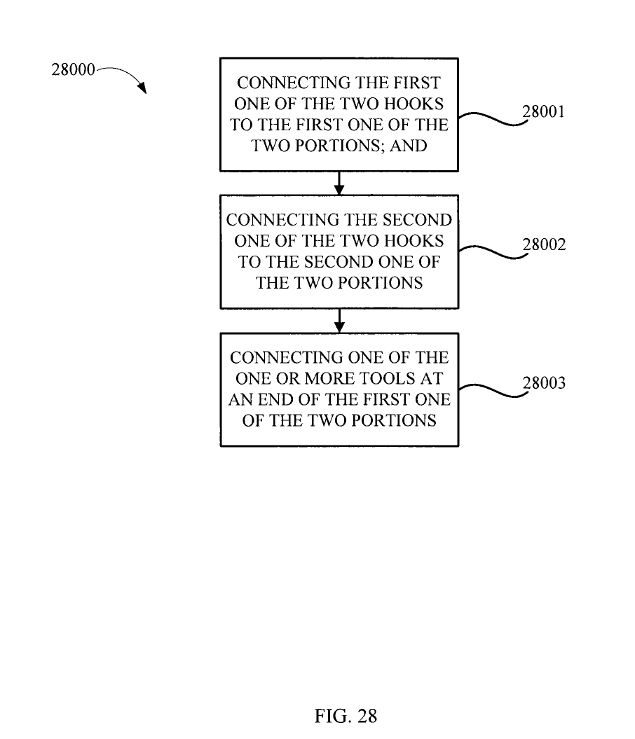

FIG. 28 depicts a method 28000, including the above described steps of connecting one or more tools to a water-proof shock-absorbing member; connecting two self-locking swivel hooks to the member, making the member have two portions; making a first one of the two portions shorter than a second on the two portions, connecting a first one of the two hooks to the first one of the two portions; connecting a second one of the two hooks to the second one of the two portions, and further including connecting one of the one or more tools on at least one of an end or along a length of the first one of the two portions.

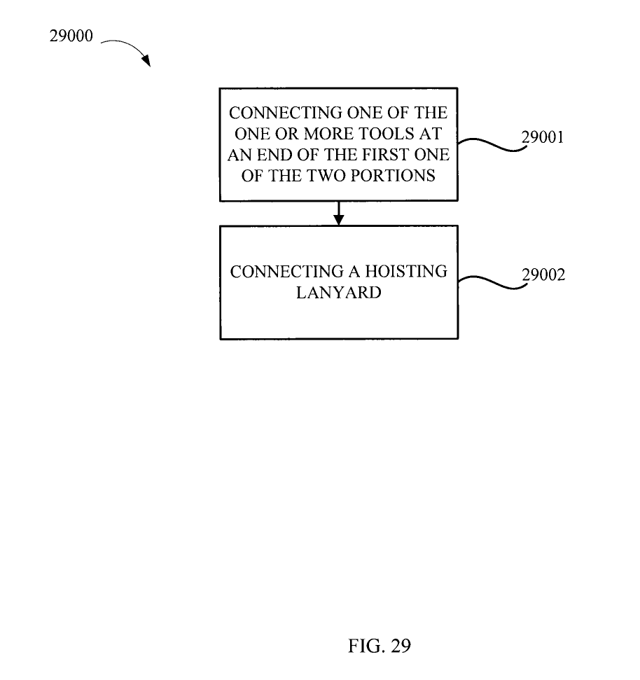

FIG. 29 depicts a method 29000, including the above described steps of connecting one or more tools to a water-proof shock-absorbing member; connecting two self-locking swivel hooks to the member, making the member have two portions; making a first one of the two portions shorter than a second on the two portions, connecting a first one of the two hooks to the first one of the two portions; connecting a second one of the two hooks to the second one of the two portions; connecting one of the one or more tools on at least one of an end or along a length of the first one of the two portions, and further including connecting a hoisting lanyard.

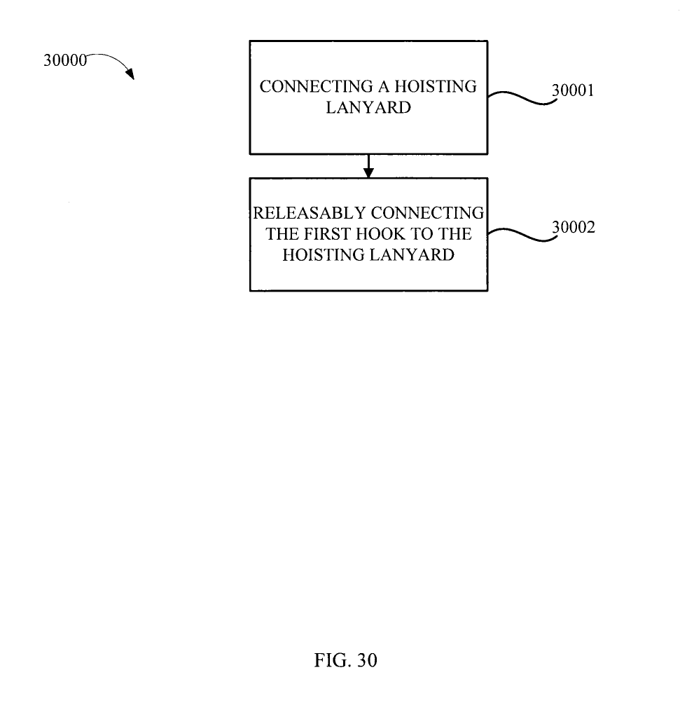

FIG. 30 depicts a method 30000, including the above described steps of connecting one or more tools to a water-proof shock-absorbing member; connecting two self-locking swivel hooks to the member, making the member have two portions; making a first one of the two portions shorter than a second on the two portions, connecting a first one of the two hooks to the first one of the two portions; connecting a second one of the two hooks to the second one of the two portions; connecting one of the one or more tools on at least one of an end or along a length of the first one of the two portions; connecting a hoisting lanyard; and further including releasably connecting the first hook to the hoisting lanyard.

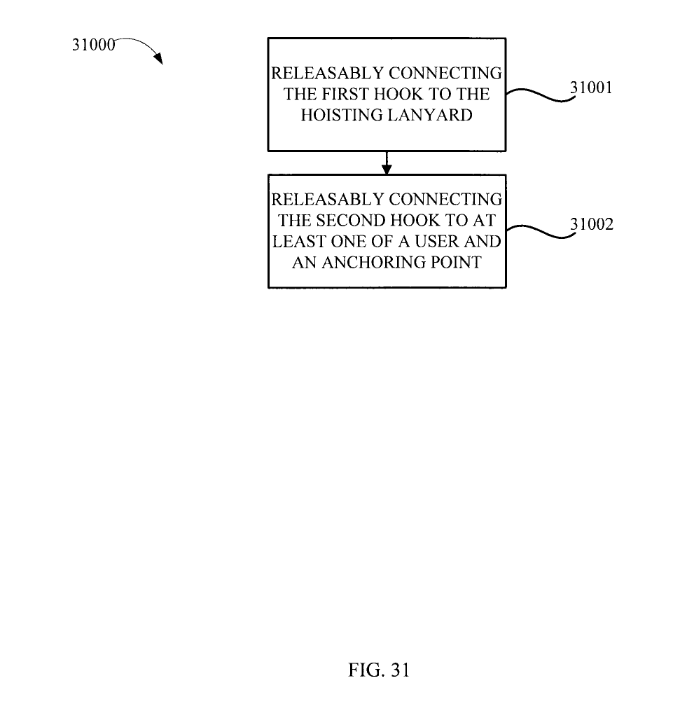

FIG. 31 depicts a method 31000, including the above described steps of connecting one or more tools to a water-proof shock-absorbing member; connecting two self-locking swivel hooks to the member, making the member have two portions; making a first one of the two portions shorter than a second on the two portions, connecting a first one of the two hooks to the first one of the two portions; connecting a second one of the two hooks to the second one of the two portions; connecting one of the one or more tools on at least one of an end or along a length of the first one of the two portions; connecting a hoisting lanyard; releasably connecting the first hook to the hoisting lanyard; and further including releasably connecting the second hook to at least one of an attachment point on a user and an anchoring point.

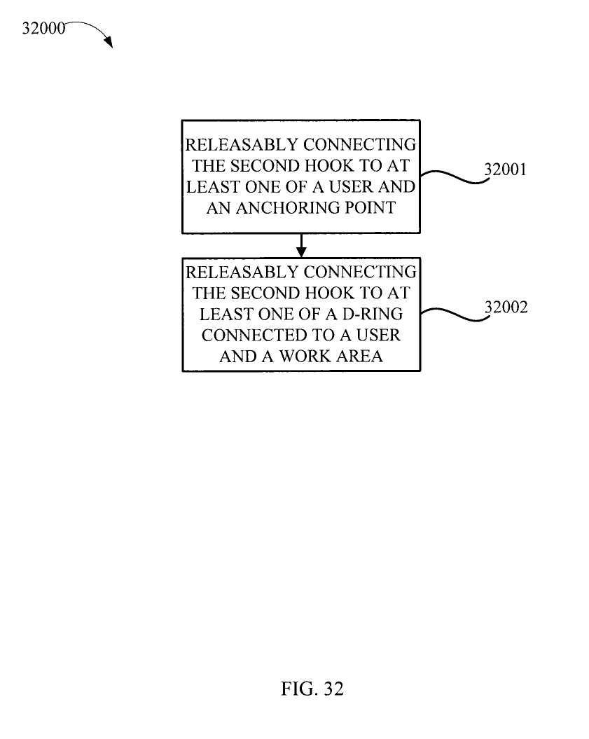

FIG. 32 depicts a method 32000, including the above described steps of connecting one or more tools to a water-proof shock-absorbing member; connecting two self-locking swivel hooks to the member, making the member have two portions; making a first one of the two portions shorter than a second on the two portions, connecting a first one of the two hooks to the first one of the two portions; connecting a second one of the two hooks to the second one of the two portions; connecting one of the one or more tools on at least one of an end or along a length of the first one of the two portions; connecting a hoisting lanyard; releasably connecting the first hook to the hoisting lanyard; releasably connecting the second hook to at least one of an attachment point on a user and an anchoring point; and further including releasably connecting the first hook to at least one of a D-Ring connected to a user and a work area.

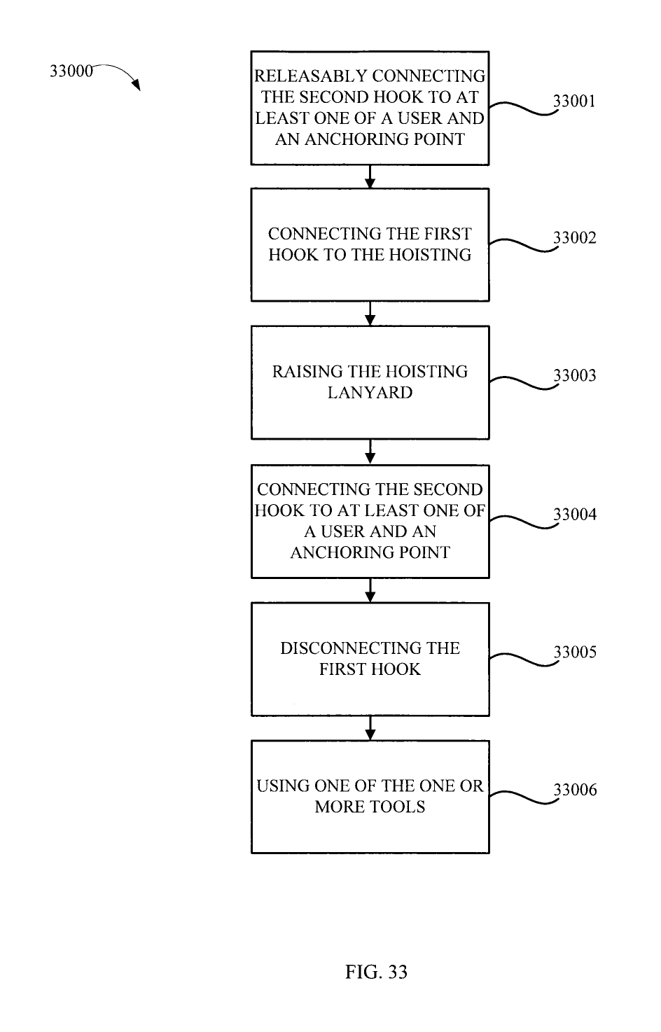

FIG. 33 depicts a method 33000, including the above described steps of connecting one or more tools to a water-proof shock-absorbing member; connecting two self-locking swivel hooks to the member, making the member have two portions; making a first one of the two portions shorter than a second on the two portions, connecting a first one of the two hooks to the first one of the two portions; connecting a second one of the two hooks to the second one of the two portions; connecting one of the one or more tools on at least one of an end or along a length of the first one of the two portions; connecting a hoisting lanyard; releasably connecting the first hook to the hoisting lanyard; releasably connecting the second hook to at least one of an attachment point on a user and an anchoring point; and further including connecting the first hook to the hoisting lanyard; raising the hoisting lanyard; connecting the second hook to the at least one of a user and an anchoring point; disconnecting the first hook; and using one of the one or more tools.

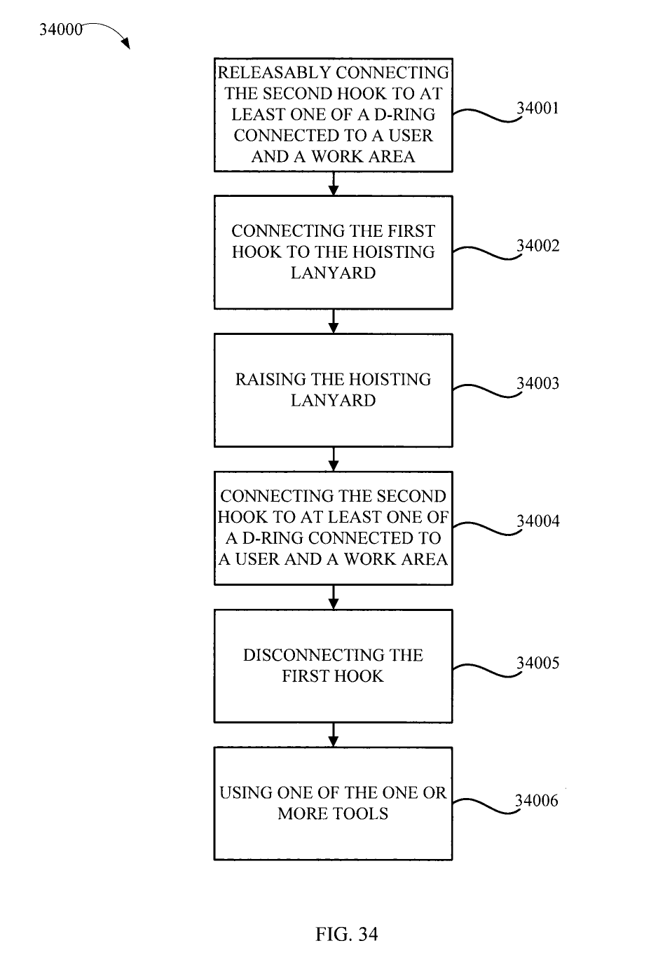

FIG. 34 depicts a method 34000, including connecting one or more tools to a water-proof shock-absorbing member; connecting two self-locking swivel hooks to the member, making the member have two portions; making a first one of the two portions shorter than a second on the two portions, connecting a first one of the two hooks to the first one of the two portions; connecting a second one of the two hooks to the second one of the two portions; connecting one of the one or more tools on at least one of an end or along a length of the first one of the two portions; connecting a hoisting lanyard; releasably connecting the first hook to the hoisting lanyard; releasably connecting the second hook to at least one of an attachment point on a user and an anchoring point; releasably connecting the second hook to at least one of a D-Ring connected to a user and a work area; and further including connecting the first hook to the hoisting lanyard; raising the hoisting lanyard; connecting the second hook to the at least one of a D-Ring connected to a user and a work area; disconnecting the first hook; and using one of the one or more tools.

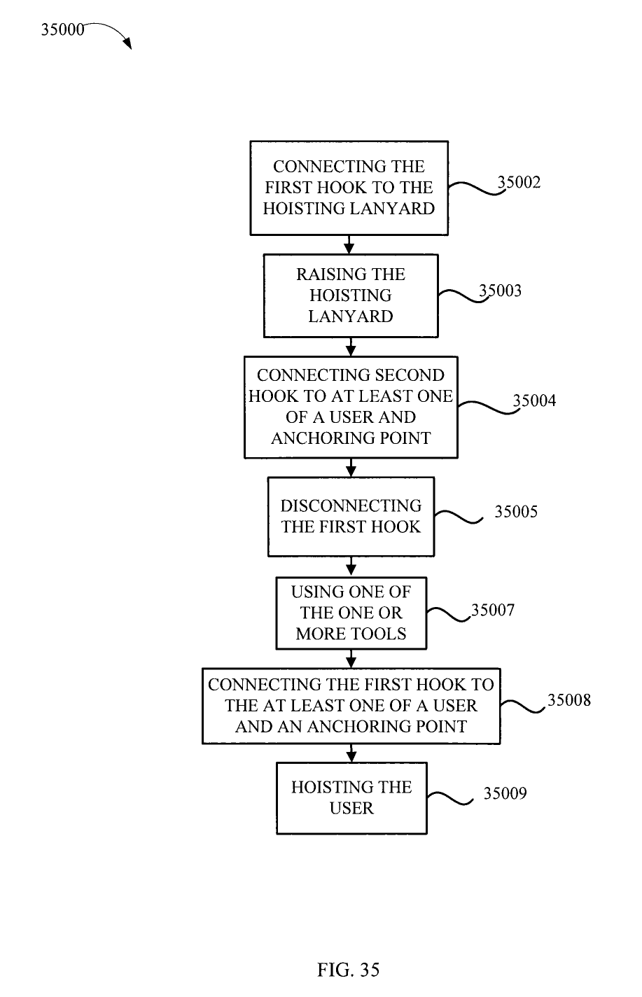

FIG. 35 depicts a method 35000, including connecting one or more tools to a water-proof shock-absorbing member; connecting two self-locking swivel hooks to the member, making the member have two portions; making a first one of the two portions shorter than a second on the two portions, connecting a first one of the two hooks to the first one of the two portions; connecting a second one of the two hooks to the second one of the two portions; connecting one of the one or more tools on at least one of an end or along a length of the first one of the two portions; connecting a hoisting lanyard; and further including connecting the first hook to the hoisting lanyard; raising the hoisting lanyard; connecting the second hook to the at least one of a user and an anchoring point; disconnecting the first hook; using one of the one or more tools; connecting the first hook to the at least one of a user and an anchoring point; and hoisting the user.

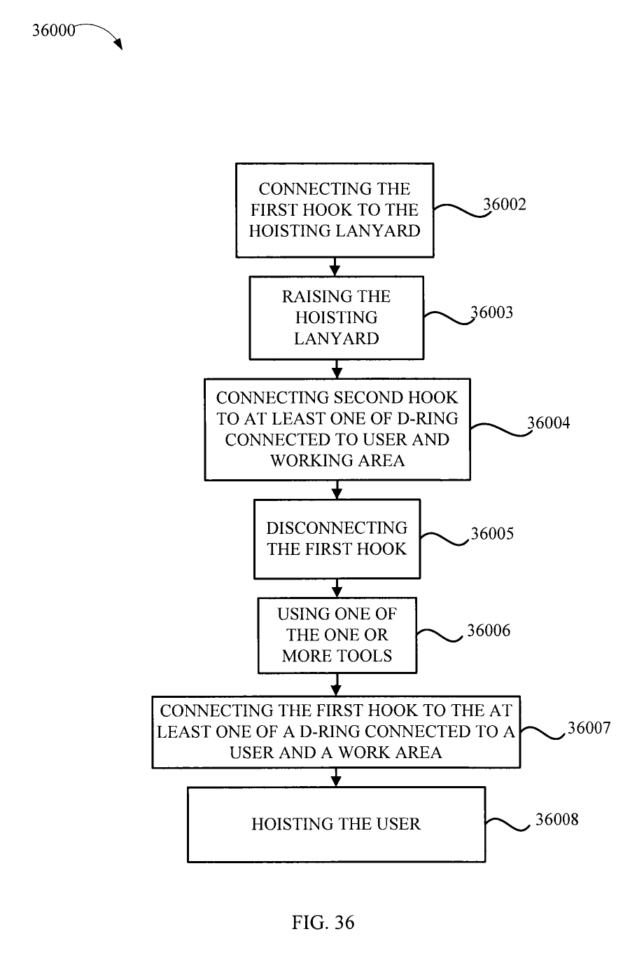

FIG. 36 depicts a method 36000, including connecting one or more tools to a water-proof shock-absorbing member; connecting two self-locking swivel hooks to the member, making the member have two portions; making a first one of the two portions shorter than a second on the two portions, connecting a first one of the two hooks to the first one of the two portions; connecting a second one of the two hooks to the second one of the two portions; connecting one of the one or more tools on at least one of an end or along a length of the first one of the two portions; connecting a hoisting lanyard; and further including connecting the first hook to the hoisting lanyard; raising the hoisting lanyard; connecting the second hook to the at least one of a D-Ring connected to a user and a work area; disconnecting the first hook; using one of the one or more tools; connecting the first hook to the at least one of a user and an anchoring point; and hoisting the user.

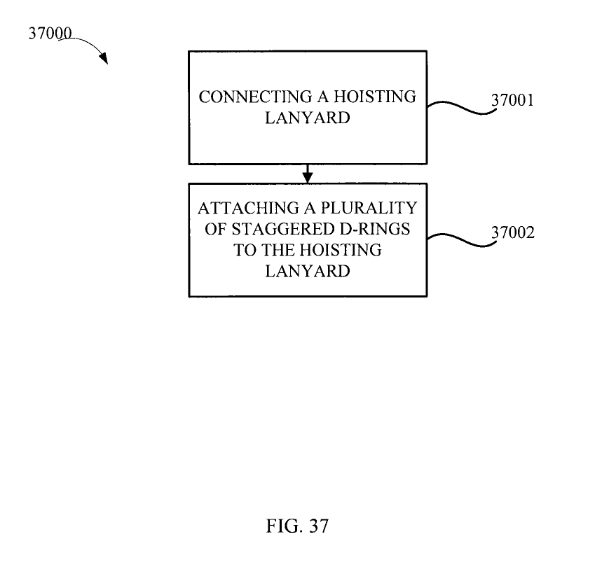

FIG. 37 depicts a method 37000, including connecting one or more tools to a water-proof shock-absorbing member; connecting two self-locking swivel hooks to the member, making the member have two portions; making a first one of the two portions shorter than a second on the two portions, connecting a first one of the two hooks to the first one of the two portions; connecting a second one of the two hooks to the second one of the two portions; connecting one of the one or more tools on at least one of an end or along a length of the first one of the two portions, connecting a hoisting lanyard; and further including attaching a plurality of staggered D-Rings to the hoisting lanyard.

The specific embodiments of systems and processes described herein are possible implementations of the present disclosure. The present disclosure is not limited to the particular implementations described herein and shown in the accompanying figures. For example, in alternate implementations, certain acts need not be performed in the order described, and may be modified, and/or may be omitted entirely, as desired. Moreover, in various implementations, the acts described may be implemented and controlled by a computer, controller, processor, programmable device, or any other suitable device, and may be based on instructions stored on one or more computer-readable media or otherwise stored or programmed into such devices.

Moreover, those persons skilled in the art will recognize that it is common within the art to describe devices and/or processes in the fashion set forth herein, and thereafter use standard engineering practices to integrate such described devices and/or processes into workable systems having the described functionality. That is, at least a portion of the devices and/or processes described herein can be developed into a workable system via a reasonable amount of experimentation.

Although specific aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims.

While various features have been described in considerable detail with reference to certain preferred embodiments, other embodiments are possible. Therefore, the spirit or scope of the appended claims should not be limited to the description of the embodiments contained herein.

What is claimed is:

1. An apparatus, comprising:
one or more tools, wherein each one of the one or more tools are connected to a shock absorbing member, wherein the shock absorbing member comprises a plurality of hooks.

2. The apparatus of claim 1, wherein the shock absorbing member comprises two hooks.

3. The apparatus of claim 2, wherein the shock absorbing member further comprises two portions, wherein the first one of the two portions is shorter than the second one of the two portions.

4. The apparatus of claim 3, wherein the first one of the two hooks is connected to the first one of the two portions and the second one of the two hooks is connected to the second one of the two portions.

5. The apparatus of claim 4, wherein one of the one or more tools is connected on at least one of an end or along a length of the first one of the two portions.

6. The apparatus of claim 5, further comprising a hoisting lanyard.

7. The apparatus of claim 6, wherein the first hook is releasably connected to the hoisting lanyard.

8. The apparatus of claim 7, wherein the second hook is releasably connected to at least one of an attachment point on a user and an anchoring point.

9. The apparatus of claim 7, wherein the second hook is releasably connected to at least one of a D-Ring connected to a user and a work area.

10. The apparatus of claim 1, wherein the shock absorbing member comprises three hooks.

11. The apparatus of claim 10, wherein the shock absorbing member further comprises three portions, wherein a first one of the three portions is shorter than a second one of a three portions and a third one of the three portions.

12. The apparatus of claim 11, wherein a first one of the three hooks is connected to the first one of the three portions, a second one of the three hooks is connected to the second one of the three portions, and a third one of the three hooks is connected to the third one of the three portions.

13. The apparatus of claim 12, wherein one of the one or more tools is connected on at least one of an end or along a length of the first one of the three portions.

14. The apparatus of claim 13, further comprising a hoisting lanyard.

15. The apparatus of claim 14, wherein the first hook is releasably connected to the hoisting lanyard.

16. The apparatus of claim 15, wherein the second hook is releasably connected to at least one of an attachment point on a user and an anchoring point.

17. The apparatus of claim 15, wherein the second hook is releasably connected to at least one of a D-Ring connected to a user and a work area.

18. The apparatus of claim 6, further comprising:
means for connecting the first hook to the hoisting lanyard;
means for raising the hoisting lanyard;
means for connecting the second hook to the at least one of a user and an anchoring point;
means for disconnecting the first hook; and
means for using one of the one or more tools.

19. The apparatus of claim 6, further comprising:
means for connecting the first hook to the hoisting lanyard;
means for raising the hoisting lanyard;
means for connecting the second hook to the at least one of a D-Ring connected to a user and a work area;
means for disconnecting the first hook; and
means for using one of the one or more tools.

20. The apparatus of claim 8, further comprising:
means for connecting the first hook to the hoisting lanyard;
means for raising the hoisting lanyard;
means for connecting the second hook to the at least one of a user and an anchoring point;
means for disconnecting the first hook;
means for using one of the one or more tools;
means for connecting the first hook to the at least one of a user and an anchoring point; and
means for hoisting the user.

21. The apparatus of claim 9, further comprising:
means for connecting the first hook to the hoisting lanyard;
means for raising the hoisting lanyard;
means for connecting the second hook to the at least one of a D-Ring connected to a user and a work area;
means for disconnecting the first hook;
means for using one of the one or more tools;
means for connecting the first hook to the at least one of a user and an anchoring point; and
means for hoisting the user.

22. The apparatus of claim 5, wherein the hoisting lanyard comprises a plurality of staggered D-Rings.

23. A system for preventing the dropping of one or more items, comprising:
a member, wherein each one of the one or more items are connected to the member, wherein the member comprises a plurality of connectors, wherein the member further comprises a plurality of portions, wherein each one of the plurality of connectors is connected to a respective one of the plurality of portions, and wherein each one of the one or more items is connected to an end of a respective one of the plurality of portions.

24. The system of claim 23, wherein at least one of the plurality of connectors is continuously connected to at least one anchoring point so as to prevent the dropping of the one or more items.

25. The system of claim 24, wherein one of the plurality of connectors is disconnected from the at least one anchoring point while at least one other one of the plurality of the connectors is connected to an anchoring point.

26. The system of claim 25, wherein the at least one anchoring point comprises at least one of an attachment point on a user, a D-Ring connected to a user, a work area, and a hoisting lanyard.

27. An apparatus, comprising:
one or more tools, wherein each one of the one or more tools are connected to a water-proof shock-absorbing member, wherein the member comprises two self-locking swivel hooks.

28. The apparatus of claim 27, wherein the member further comprises two portions.

29. The apparatus of claim 28, wherein the first one of the two hooks is connected to the first one of the two portions and the second one of the two hooks is connected to the second one of the two portions.

30. The apparatus of claim 29, wherein one of the one or more tools is connected on at least one of an end or along a length of the first one of the two portions.

31. The apparatus of claim 30, further comprising a hoisting lanyard.

32. The apparatus of claim 31, wherein the first hook is releasably connected to the hoisting lanyard.

33. The apparatus of claim 32, wherein the second hook is releasably connected to at least one of an attachment point on a user and an anchoring point.

34. The apparatus of claim 33, wherein the second hook is releasably connected to at least one of a D-Ring connected to a user and a work area.

35. The apparatus of claim 31, further comprising:
means for connecting the first hook to the hoisting lanyard;
means for raising the hoisting lanyard;
means for connecting the second hook to the at least one of a user and an anchoring point;
means for disconnecting the first hook; and
means for using one of the one or more tools.

36. The apparatus of claim 31, further comprising:
means for connecting the first hook to the hoisting lanyard;
means for raising the hoisting lanyard;
means for connecting the second hook to the at least one of a D-Ring connected to a user and a work area;
means for disconnecting the first hook; and
means for using one of the one or more tools.

37. The apparatus of claim 33, further comprising:
means for connecting the first hook to the hoisting lanyard;
means for raising the hoisting lanyard;
means for connecting the second hook to the at least one of a user and an anchoring point;
means for disconnecting the first hook;
means for using one of the one or more tools;
means for connecting the first hook to the at least one of a user and an anchoring point; and
means for hoisting the user.

38. The apparatus of claim 34, further comprising:
means for connecting the first hook to the hoisting lanyard;
means for raising the hoisting lanyard;
means for connecting the second hook to the at least one of a D-Ring connected to a user and a work area;
means for disconnecting the first hook;
means for using one of the one or more tools;
means for connecting the first hook to the at least one of a user and an anchoring point; and
means for hoisting the user.

39. The apparatus of claim 31, wherein the hoisting lanyard comprises a plurality of staggered D-Rings.

40. A system for preventing the dropping of one or more items, comprising:
a water-proof shock-absorbing member, wherein each one of the one or more items are connected to the member, wherein the member comprises a plurality of swivel connectors, wherein the member further comprises a plurality of portions, wherein each one of the plurality of connectors is connected to a respective one of the plurality of portions, and wherein each one of the one or more items is connected to at least one of an end or along a length of a respective one of the two portions.

41. The system of claim 40, wherein at least one of the plurality of connectors is continuously connected to at least one anchoring point so as to prevent the dropping of the one or more items.

42. The system of claim 41, wherein one of the plurality of connectors is disconnected from the at least one anchoring point while at least one other one of the plurality of the connectors is connected to an anchoring point.

43. The system of claim 42, wherein the anchoring point comprises at least one of an attachment point on a user, a D-Ring connected to a user, a work area, and a hoisting lanyard.

44. An apparatus, comprising:
one or more tools, wherein the one or more tools comprises one or more tool connecting members; and
a hoisting member, wherein the hoisting member comprises one or more hoisting connecting portions, wherein the hoisting member can be used to raise the one or more tools by connecting a respective one of the one or more tool connecting members to at least one of the one or more hoisting connecting portions;
wherein the one or more tools is continuously connected to at least one tie-off point so that when any one of the one or more tool connecting members is disconnected to use a respective one of the one or more tools, at least another one of the one or more tool connecting members remains connected to the tie-off point.

45. The apparatus of claim 44, wherein the hoisting member further comprises:
a tie back member, wherein the tie back member can further be used to connect the hoisting member to an anchoring point.

46. The apparatus of claim 45, wherein the tie back member comprises:
a sliding portion, wherein the sliding portion slides along a length of the hoisting member; and
a connecting portion, wherein the connecting portion may be used to connect the hoisting member to an anchoring point.

47. The apparatus of claim 46, wherein the sliding portion and the connecting portion cooperate to exert a releasable immobilizing pressure on the hoisting member, wherein the releasable immobilizing pressure prevents the sliding portion and the connecting portion from sliding along the hoisting member.

48. The apparatus of claim 45, wherein at least one of the one or more tool connecting members comprises:
a shock absorbing member.

49. The apparatus of claim 48, wherein the shock absorbing member comprises:
a stretch material, wherein the stretch material is extendable when a force is applied.

50. The apparatus of claim 49, wherein a user attaches one of the plurality of tool connecting means to an attachment point on a user and wherein the stretch material can extend itself so that a force applied to the attachment point when a respective one of the one or more tools is dropped is substantially minimized.

51. The apparatus of claim 50, wherein the force is substantially below the force likely to cause injury to a user.

52. The apparatus of claim 48, wherein a user attaches one of the plurality of tool connecting means to an attachment point on a user and wherein the shock absorbing member can extend itself so that a force applied to the attachment point when a respective one of the one or more tools is dropped is substantially minimized.

53. The apparatus of claim 52, wherein the force is substantially below the force likely to cause injury to a user.

54. The apparatus of claim 52, wherein the shock absorbing member comprises one or more hooks.

55. The apparatus of claim 54, wherein a first one of the one or more tool connecting members is shorter than a second one of the one or more tool connecting members and wherein at least one of the first one and the second one of the one or more tool connecting members comprises the shock absorbing member.

56. The apparatus of claim 55, wherein a first one of the one or more hooks is connected to the first one of the one or more tool connecting members and a second one of the one or more hooks is connected to the second one of the one or more tool connecting members.

57. The apparatus of claim 56, wherein one of the one or more tools is connected on at least one of an end or along a length of the first one of the one or more tool connecting members.

58. The apparatus of claim 56, wherein the first hook is releasably connected to the hoisting member.

59. The apparatus of claim 57, wherein the second hook is releasably connected to at least one of the attachment point and an anchoring point.

60. The apparatus of claim 57, wherein the second hook is releasably connected to at least one of a D-Ring connected to a user and a work area.

61. The apparatus of claim 55, wherein the shock absorbing member further comprises:
water proof material.

62. The apparatus of claim 55, wherein the hoisting member comprises:
a connecting portion, wherein the connecting portion comprises a plurality of D-rings, wherein each one of the one or more tools may be connected to the hoisting member by connecting each one of the one or more tool connecting members to a respective one of the plurality of D-rings.

63. The apparatus of claim 62, wherein the plurality of D-rings are staggered along a length of the connecting portion so as to allow access to each one of the one or more tools without having to at least one of raising or lowering the hoisting member.

64. The apparatus of claim 63, wherein the one or more tools comprises at least one of:
one or more hoisting lanyards;
one or more pry bars;
one or more wrenches;
one or more hammers;
one or more tapes;
one or more bucket slings;
one or more screwdrivers;
one or more hoisting lanyards; and
one or more grease guns.

65. The apparatus of claim 63, wherein the one or more tools comprises at least one of:
one or more hoisting lanyards;
one or more pry bars;
one or more wrenches;
one or more hammers;
one or more tapes;
one or more bucket slings;
one or more screwdrivers;
one or more grease guns; and
one or more specialty tool tethers.

66. The apparatus of claim 63, wherein one or more tools comprises at least one of:
one or more hoisting lanyards;
one or more pry bars;
one or more wrenches;
one or more hammers;
one or more tapes;
one or more bucket slings;
one or more screwdrivers;
one or more hoisting lanyards;
one or more grease guns; and
one or more storage boxes.

67. A method comprising, comprising:
connecting one or more tools to a shock absorbing member; and
connecting a plurality of hooks to the shock absorbing member .

68. The method of claim 67, further comprising:
connecting two hooks to the shock absorbing member.

69. The method of claim 68, further comprising:
making the shock absorbing member have two portions; and
making a first one of the two portions shorter than a second one of the two portions.

70. The method of claim 69, further comprising:
connecting the first one of the two hooks to the first one of the two portions; and
connecting the second one of the two hooks to the second one of the two portions.

71. The method of claim 70, further comprising:
connecting one of the one or more tools on at least one of an end or along a length of the first one of the two portions.

72. The method of claim 71, further comprising:
connecting a hoisting lanyard.

73. The method of claim 72, further comprising:
releasably connecting the first hook to the hoisting lanyard.

74. The method of claim 73, further comprising:
releasably connecting the second hook to at least one of an attachment point on a user and an anchoring point.

75. The method of claim 73, further comprising:
releasably connecting the second hook to at least one of a D-Ring connected to a user and a work area.

76. The method of claim 67, further comprising:
connecting three hooks to the shock absorbing member.

77. The method of claim 76, further comprising:
making the shock absorbing member have three portions;
making a first one of the three portions be shorter than a second one of a three portions and a third one of the three portions.

78. The method of claim 77, further comprising:
connecting a first one of the three hooks to the first one of the three portions;
connecting a second one of the three hooks to the second one of the three portions; and
connecting a third one of the three hooks to the third one of the three portions.

79. The method of claim 78, further comprising:
connecting one of the one or more tools on at least one of an end or along a length of the first one of the three portions.

80. The method of claim 79, further comprising:
connecting a hoisting lanyard.

81. The method of claim 80, further comprising:
releasably connecting the first hook to the hoisting lanyard.

82. The method of claim 81, further comprising:
releasably connecting the second hook to at least one of an attachment point on a user and an anchoring point.

83. The method of claim 81, further comprising:
releasably connecting the second hook to at least one of a D-Ring connected to a user and a work area.

84. The method of claim 72, further comprising:
connecting the first hook to the hoisting lanyard;
raising the hoisting lanyard;
connecting the second hook to the at least one of a user and an anchoring point;
disconnecting the first hook; and
using one of the one or more tools.

85. The method of claim 72 further comprising:
connecting the first hook to the hoisting lanyard;
raising the hoisting lanyard;
connecting the second hook to the at least one of a D-Ring connected to a user and a work area;
disconnecting the first hook; and
using one of the one or more tools.

86. The method of claim 74, further comprising:
connecting the first hook to the hoisting lanyard;
raising the hoisting lanyard;
connecting the second hook to the at least one of a user and an anchoring point;
disconnecting the first hook;
using one of the one or more tools;
connecting the first hook to the at least one of a user and an anchoring point; and
hoisting the user.

87. The method of claim 75, further comprising:
connecting the first hook to the hoisting lanyard;
raising the hoisting lanyard;
connecting the second hook to the at least one of a D-Ring connected to a user and a work area;
disconnecting the first hook;
using one of the one or more tools;
connecting the first hook to the at least one of a user and an anchoring point; and
hoisting the user.

88. The method of claim 71, further comprising:
providing on the hoisting lanyard a plurality of staggered D-Rings.

89. A method for preventing the dropping of one or more items, comprising:
connecting each one of the one or more items to a member;
attaching a plurality of connectors to the member;
providing a plurality of portions for the member;
connecting each one of the plurality of connectors to a respective one of the plurality of portions; and
connecting each one of the one or more items to an end of a respective one of the two portions.

90. The method of claim 89, further comprising:
continuously connecting at least one of the plurality of connectors to at least one anchoring point so as to prevent the dropping of the one or more items.

91. The method of claim 90, further comprising:
disconnecting one of the plurality of connectors from the at least one anchoring point while at least one other one of the plurality of the connectors is connected to an anchoring point.

92. The method of claim 91, further comprising:
providing as the at least one anchoring point at least one of a user, a D-Ring connected to a user, a work area, and a hoisting lanyard.

93. A method, comprising:
connecting one or more tools to a water-proof shock-absorbing member; and
connecting two self-locking swivel hooks to the member.

94. The method of claim 93, further comprising:
making the member have two portions; and
making a first one of the two portions shorter than a second on the two portions.

95. The method of claim 94, further comprising:
connecting a first one of the two hooks to the first one of the two portions; and
connecting a second one of the two hooks to the second one of the two portions.

96. The method of claim 95, further comprising:
connecting one of the one or more tools on at least one of an end or along a length of the first one of the two portions.

97. The method of claim 96, further comprising:
connecting a hoisting lanyard.

98. The method of claim 97, further comprising:
releasably connecting the first hook to the hoisting lanyard.

99. The method of claim 98, further comprising:
releasably connecting the second hook to at least one of an attachment point on a user and an anchoring point.

100. The method of claim 99, further comprising:
releasably connecting the second hook to at least one of a D-Ring connected to a user and a work area.

101. The method of claim 97, further comprising:
connecting the first hook to the hoisting lanyard;
raising the hoisting lanyard;
connecting the second hook to the at least one of a user and an anchoring point;
disconnecting the first hook; and
using one of the one or more tools.

102. The method of claim 97, further comprising:
connecting the first hook to the hoisting lanyard;
raising the hoisting lanyard;
connecting the second hook to the at least one of a D-Ring connected to a user and a work area;
disconnecting the first hook; and
using one of the one or more tools.

103. The method of claim 99, further comprising:
connecting the first hook to the hoisting lanyard;
raising the hoisting lanyard;
connecting the second hook to the at least one of a user and an anchoring point;
disconnecting the first hook;
using one of the one or more tools;
connecting the first hook to the at least one of a user and an anchoring point; and
hoisting the user.

104. The method of claim 100, further comprising:
connecting the first hook to the hoisting lanyard;
raising the hoisting lanyard;
connecting the second hook to the at least one of a D-Ring connected to a user and a work area;
disconnecting the first hook;
using one of the one or more tools;
connecting the first hook to the at least one of a user and an anchoring point; and
hoisting the user.

105. The method of claim 97, further comprising:
attaching a plurality of staggered D-Rings to the hoisting lanyard.

106. A method for preventing the dropping of one or more items, comprising:
connecting one or more items to a water-proof shock-absorbing member;
providing a plurality of swivel connectors on the member;
providing a plurality of portions on the member;
connecting each one of the plurality of swivel connectors to a respective one of the plurality of portions; and
connecting each one of the one or more items to at least one of an end or along a length of a respective one of the two portions.

107. The method of claim 106, further comprising:
continuously connecting at least one of the plurality of connectors to at least one anchoring point so as to prevent the dropping of the one or more items.

108. The method of claim 107, further comprising:
disconnecting one of the plurality of connectors from the at least one anchoring point while at least one other one of the plurality of the connectors is connected to an anchoring point.

109. The method of claim 108, further comprising:
providing the at least one anchoring point on at least one of an attachment point on a user, a D-Ring connected to a user, a work area, and a hoisting lanyard.

110. A method, comprising:
providing one or more tool connecting members on one or more tools;
providing one or more hoisting connecting portions on a hoisting member;
connecting a respective one of the one or more tool connecting members to at least one of the one or more hoisting connecting portions;
raising the hoisting member to raise the one or more tools; and
continuously connecting the one or more tools to at least one tie-off point so that when any one of the one or more tool connecting members is disconnected to use a respective one of the one or more tools, at least another one of the one or more tool connecting members remains connected to the tie-off point.

111. The method of claim 110, further comprising:
connecting the hoisting member to an anchoring point using a tie back member.

112. The method of claim 111, wherein the tie back member comprises:
a sliding portion, wherein the sliding portion slides along a length of the hoisting member; and
a connecting portion, wherein the connecting portion may be used to connect the hoisting member to an anchoring point.

113. The method of claim 112, wherein the sliding portion and the connecting portion cooperate to exert a releasable immobilizing pressure on the hoisting member, wherein the releasable immobilizing pressure prevents the sliding portion and the connecting portion from sliding along the hoisting member.

114. The method of claim 111, further comprising:
providing shock absorbing member on at least one of the one or more tool connecting members.

115. The method of claim 114, further comprising:
providing a stretch material for the shock absorbing member, wherein the stretch material is extendable when a force is applied.

116. The method of claim 114, further comprising:
attaching one of the plurality of tool connecting means to an attachment point on a user;
enabling the stretch material to extend itself so that a force applied to the attachment point when a respective one of the one or more tools is dropped is substantially minimized.

117. The method of claim 115, wherein the force is substantially below the force likely to cause injury to a user.

118. The method of claim 114, further comprising:
attaching one of the plurality of tool connecting means to an attachment point on a user; and
enabling the shock absorbing member to extend itself so that a force applied to the attachment point when a respective one of the one or more tools is dropped is substantially minimized.

119. The method of claim 118, wherein the force is substantially below the force likely to cause injury to a user.

120. The method of claim 115, further comprising:
providing one or more hooks on the shock absorbing member.

121. The method of claim 120, further comprising:
making a first one of the one or more tool connecting members shorter than a second one of the one or more tool connecting members; and
providing the shock absorbing member on at least one of the first one and the second one of the one or more tool connecting members.

122. The method of claim 121, further comprising:
connecting a first one of the one or more hooks to the first one of the one or more tool connecting members; and
connecting a second one of the one or more hooks to the second one of the one or more tool connecting members.

123. The method of claim 122, further comprising:
connecting one of the one or more tools on at least one of an end or along a length of the first one of the one or more tool connecting members.

124. The method of claim 122, further comprising:
releasably connecting the first hook to the hoisting member.

125. The method of claim 123, further comprising:
releasably connecting the second hook to at least one of the attachment point and an anchoring point.

126. The method of claim 123, further comprising:
releasably connecting the second hook to at least one of a D-Ring connected to a user and a work area.

127. The method of claim 121, further comprising:
providing water proof material on the shock absorbing member.

128. The method of claim 121, further comprising:
providing a connecting portion on the hoisting member; and
providing on the connecting portion a plurality of D-rings, wherein each one of the one or more tools may be connected to the hoisting member by connecting each one of the one or more tool connecting members to a respective one of the plurality of D-rings.

129. The method of claim 128, further comprising:
staggering the plurality of D-rings along a length of the connecting portion so as to allow access to each one of the one or more tools without having to at least one of raising or lowering the hoisting member.

130. The method of claim 129, further comprising:
providing the one or more tools, comprising at least one of
one or more hoisting lanyards;
one or more pry bars;
one or more wrenches;
one or more hammers;
one or more tapes;
one or more bucket slings;
one or more screwdrivers;
one or more hoisting lanyards; and
one or more grease guns.

131. The method of claim 129, further comprising:
providing the one or more tools, comprising at least one of
one or more hoisting lanyards;
one or more pry bars;
one or more wrenches;
one or more hammers;
one or more tapes;
one or more bucket slings;
one or more screwdrivers;
one or more grease guns; and
one or more specialty tool tethers.

132. The method of claim 129, further comprising:
providing one or more tools, comprising at least one of one or more hoisting lanyards;
one or more pry bars;
one or more wrenches;
one or more hammers;
one or more tapes;
one or more bucket slings;
one or more screwdrivers;
one or more hoisting lanyards;
one or more grease guns; and
one or more storage boxes.
